(19) United States
(12) Patent Application Publication
(10) Pub. No.: US 2005/0152218 A1
(43) Pub. Date: Jul. 14, 2005

(54) Wave blocking systems and methods

(76) Inventor: Youngtack Shim, Port Moody (CA)

Correspondence Address: Youngtack Shim, 155 Aspenwood Drive, Port Moody, BC, Y3H 5A5, CA

(21) Appl. No.: 10/755,004

(22) Filed: Jan. 12, 2004

(51) Int. Cl. H04K 3/00

(52) U.S. Cl. 367/1

(57) ABSTRACT

The present invention generally relates to various wave blocking systems and related methods for detecting a location of a wave source emitting various waves and for adaptively disposing at least one blocking member between a target object and source to at least substantially block propagation of such waves to the target object. The wave blocking system may include at least one sensor member for receiving a first portion of the waves and generating a signal in response to such a first portion of the waves, at least one blocking member for receiving a second portion of the waves and for blocking transmission of such a portion of the waves therethrough, at least one control member for assessing a location of the wave source from the signal from the sensor member, for determining a target line passing through the wave source and target object, and to dispose at least a portion of the blocking member to a position nearest to the target line. Accordingly, the wave blocking system and methods of the present invention may at least substantially block propagation of the above waves toward the target object, thereby preventing drivers or operators of various transportation, construction, medical, and/or scientific equipment and/or instruments from being directly irradiated by hazardous, harmful or irritating waves.

The present application claims a benefit of an earlier document (Disclosure Document Number 508,257) which is entitled “Wave Blocking System” and filed on Feb. 12, 2002, an entire portion of which is incorporated herein by reference.

### FIELD OF THE INVENTION

The present invention generally relates to various wave blocking systems and related methods for detecting a location of a wave source irradiating various acoustic and/or electromagnetic waves and for adaptively disposing at least one blocking member between a target object and such a source in order to at least substantially block propagation of such waves toward the target object. The wave blocking system typically includes: (1) at least one sensor member arranged to receive at least a first portion of the waves and to generate at least one signal in response to the first portion of the waves; (2) at least one blocking member arranged to receive at least a second portion of the waves and to at least substantially block propagation of such a second portion of the waves therethrough; and (3) at least one control member arranged to determine the location of the wave source at least substantially based on the signal generated by the sensor member, to determine a target line which originates from the wave source toward the target object, and to dispose at least a portion of the blocking member at least substantially along the target line. Accordingly, the wave blocking system and methods therefor of the present invention may at least substantially block propagation of the above waves toward the target object, thereby preventing drivers or operators of various transportation, construction, medical, and/or scientific equipment and/or instruments from being directly irradiated by hazardous, harmful or irritating waves. In particular, when the wave blocking system and their methods of this invention are used for transportation equipment such as automobiles, motorcycles, bicycles, airplanes, ships, and so on, the drivers or operators thereof may enjoy a satisfactory forward view even when they have to operate such vehicles while directly staring in the direction of the sun during the day time or in the direction of headlights of oncoming vehicles or street lights during the night time. The wave blocking systems and their methods of the present invention may also be incorporated into helmets of drivers or operators such that they may be similarly protected regardless of the types of the vehicles and/or equipment which they have to handle. In addition, various wave blocking systems and their methods of the present invention may be applied when the wave source and/or target object may stationary or mobile. As will be described in greater detail below, various blocking members of this invention may also be arranged to block at least substantial propagation or transmission of the waves therethrough by employing many different embodiments, while various control members therefor may be arranged to control such blocking members by numerous control algorithms.

### BACKGROUND OF THE INVENTION

Anyone who has ever driven an automobile would have suffered from a poor forward view when he or she would be driving in the direction of the sun. This problem is generally intensified as the sun impinges its light upon the driver at lower incident angles, e.g., during the sunrise, sunset or winter. As a remedy, the driver has to wear sunglasses and/or put down a blocker to prevent the sun from directly illuminating his or her eyes. When the incident angle of the sunlight is extremely low, however, the driver has to sit up high or has to swivel around a driving seat in order to hide from the sun. When the driver is driving the automobile in a direction opposite to the sun, back windows and/or side windows of other automobiles moving in front of the driver may also reflect the sunlight directly to the driver and hinder his or her forward view. Workers operating construction equipment such as bulldozers, forklifts, and cranes may have to work at one site for hours while suffering from the sun directly in their eyes. Installing large light shields in front of the drivers or workers does not solve the problem, for the larger the light shields are, the more forward view of the drivers is blocked thereby. Such a problem of poor forward views may not be limited to the sunlight either. For example, driving at night may be hazardous when the forward view of the driver is hindered by bright street lights or headlights of oncoming vehicles moving on the other side of the road. Operators of various medical or scientific instruments such as lasers or X-rays face the same problem of protecting themselves from being irradiated by hazardous, harmful or irritating waves. In addition, a person in a house or working in a building may also prefer, from time to time, not to receive the sunlight in their eyes. Pulling down a blinder may constitute a poor remedy at the cost of reducing overall illumination of a room or an office.

Accordingly, there is a need to provide various wave blocking systems and methods therefor to at least substantially block the drivers or operators of various equipment or instruments from being directly illuminated by various waves irradiated by the wave source, while providing the operators or drivers with satisfactory forward views.

### SUMMARY OF THE INVENTION

The present invention generally relates to various wave blocking systems and their methods to detect a location of a wave source irradiating acoustic and/or electromagnetic waves and to dispose at least one blocking member adaptively between a target object and such a wave source so as to at least substantially block transmission or propagation of such waves toward the target object.

In one aspect of the present invention, a wave blocking system is provided to protect at least one target object from receiving various waves emitted by at least one wave source. Such a system generally includes at least one sensor member, at least one blocking member, and at least one control member. The sensor member is arranged to receive the waves and to generate at least one signal in response thereto. The blocking member may include at least one body and various blocking elements such as, e.g., at least one first blocking element and/or at least one second blocking element. Though the blocking member may generally include only one type of blocking elements, e.g., either the first or second blocking elements, hybrid blocking members may include different types of blocking elements. The first and second blocking elements are arranged to be respectively movably and fixedly coupled to the body. The first blocking element is arranged to receive the waves and also to prevent at least a portion of such waves from transmitting therethrough, while the second blocking element is arranged to operate in one of a blocking and non-blocking state, where the second blocking element prevents at least a portion of the waves received thereby from transmitting therethrough in the blocking state and transmit such a portion of the waves therethrough in the non-blocking state. The control member may be arranged to receive the signal generated by the sensor member, to assess a position of the wave source and/or target object at least substantially based on the signal, to calculate a target line which passes through the wave source and target point, and to determine a target point along the target line. Thereafter, the control member activates the first and/or second blocking elements and moves at least one of the first blocking elements to the target point or toward another point nearest to the target line or, in the alternative, manipulates at least one of the second blocking elements disposed at the target point or at another point nearest to the target line from its non-blocking state to its blocking state, while keeping other second blocking elements in their non-blocking state. Therefore, such a wave blocking system spares the target object from being directly illuminated by the waves which would otherwise have illuminated the target object. In general, the wave blocking system may be used to block various waves such as, e.g., visible light rays, ultraviolet rays, infrared rays, lasers, acoustic waves, particle rays, X-rays, cosmic rays, light rays emitted by, e.g., electroluminescent or light-emitting devices, light bulbs, sun, and the like.

The wave blocking systems and their methods of the present invention described heretofore and hereinafter offer numerous benefits over the prior art. The wave blocking systems and methods may employ various adaptive algorithms to block the waves from the target object regardless of the position of the wave source. Accordingly, whether the wave source may change its position and/or orientation or whether the target object may change its position with respect to the wave source, the wave blocking systems may adaptively calculate a new target line and target point and manipulate the blocking member to block the waves from directly illuminating the target object. Such wave blocking systems and methods are versatile in that they may be applied to protect more than one target object from the waves emitted by a single or multiple wave sources. Another advantage of such systems and methods of this invention lies in the fact that they may only block the waves at or near the target line and/or point. Thus, the target object may maintain an optimum forward view, while the blocking member blocks only a minimum portion thereof. Depending upon the mechanisms of operation, such wave blocking systems of the present invention may be arranged to be self-powered. For example, photovoltaic cells may be used not only to generate electric signals in response to the waves but also to use extra electric energy in operating the control member to calculate the target line and point and to power the rest of the wave blocking system. The wave blocking systems and their methods of this invention also allow easy calibration for determining a precise location of the target point. This feature allows the use of such systems to protect various target objects having different shapes and/or sizes from the waves. Furthermore, depending upon transmission, absorption or reflection characteristics of the blocking member, the wave systems and methods of the present invention may be employed to block the waves having different characteristics in order to protect the drives or operators of various transportation vehicles, construction vehicles, medical instruments, scientific instruments, and others from hazardous, harmful or irritating waves. Thus, such wave blocking systems and methods may be applied to various land, surface, air, and/or space vehicles examples of which may include, but not be limited to, automobiles, motorcycles, bikes, construction or military equipment, surface ships, airplanes, space ships, and the like, in order to protect the drivers and/or operators thereof from various waves examples of which may include, but not be limited to, visible light rays, ultraviolet rays, infrared rays, lasers, acoustic waves, particle rays, X-rays, cosmic rays, light rays emitted by electroluminescent or light-emitting devices, light rays emitted by various light bulbs, sun, and so on. In addition, such wave blocking systems and methods may also be used in residential or work settings in order to keep the sun from directly illuminating a person inside the house, building, and the like.

Embodiments of this aspect of the invention may include one or more of the following features.

The target object may be a human driver or an operator of automobiles, motorcycles, bicycles, land vehicles including construction equipment or military vehicles, surface vessels, airplanes, space ships, scientific or medical wave emitting or receiving device, and so on. The wave source may be a light bulb, light-emitting device, electroluminescent device, scientific or medical wave emitting device, sound wave generator, speaker, X-ray bulb, laser tube, nuclear reactor, and sun.

The sensor member may receive a first portion of such waves, whereas the blocking member may block a second portion of the waves which is different from the first portion. In the alternative, the sensor member may receive a portion of the waves and the blocking member may block at least a substantially identical portion of such waves. The sensor member may include at least one base and at least one sensing element which is supported by the base and arranged to generate the signal with an amplitude which is determined by, e.g., incident angles between the sensing elements and waves, various time-domain and/or frequency-domain wave characteristics examples of which may include, but not be limited to, amplitudes, wave lengths and/or periods, frequencies, phase angles, harmonics, distribution of thereof, and the like. Such sensing elements may be conventional photovoltaic cells and charge-coupled devices each of which may be arranged to generate the signal such as the electric current or voltage.

The target object is generally disposed to face a forward direction. When the sensor member includes multiple sensing elements or sensors, at least one of the sensing elements may be disposed to face the same forward direction so that the target object and at least one of the sensing elements may form at least substantially identical incident angles with the waves. The sensor member may also include multiple sensing elements at least two of which may form different or identical incident angles with such waves. When the sensor member includes multiple sensing elements, the sensor member may be arranged to generate at least one compound signal corresponding to an average of at least two signals generated by at least two of such sensing elements.

The sensor member may also include at least one sensor unit which may be disposed on the base of the sensor member and which may include at least one sensing element therein. At least one of the sensor units may be arranged to be disposed to face the forward direction of the target object such that both of the target object and sensing element of the sensor unit form at least substantially identical incident angles with the waves. Two or more of such sensor units may be disposed on the base of the sensor member at different or at least substantially identical tilt angles, where the base may be arranged to be at least substantially flat, curved or a combination thereof.

Such a sensor member may include at least one rotator and/or translator. The rotator may be arranged to rotate at least one sensing element or sensor unit in a first direction at least substantially vertical to the base, in a second direction at least substantially parallel with the base, and/or in a third direction which is a combination of the first and second directions. The translator may be arranged to move or translate at least one sensing element or sensor unit along an axis of the base of the sensor member, thereby allowing at least one of the sensing elements or sensor units to receive the waves at multiple incident angles. Alternatively, the sensor member may include a single sensing element or a single sensor unit arranged to receive the waves at multiple incident angles. The sensor member may also include at least one wave reflector which may be include at least one reflecting surface and may be arranged to reflect the waves by the reflecting surface to or toward at least one sensing element or sensor unit. At least one of the reflecting surfaces of the wave reflector may reflect the waves in an angle that the target object and at least one of the sensing elements may form at least substantially identical incident angles with the waves. The wave reflector may include multiple reflecting surfaces at least two of which may receive the waves at different angles. The sensor member may include at least one rotator and/or translator, where the rotator is arranged to rotate the wave reflector in a first direction at least substantially vertical to the base, in a second direction at least substantially parallel with the base, and/or a third direction which is a combination of the first and second directions, and where the translator is arranged to move the wave reflector along any axis of the base and/or at any angle with respect to such axis, thereby allowing the wave reflector to reflect the waves at multiple angles toward at least one sensing element or sensor unit.

The first blocking element of the blocking member may be made of or include any semi-opaque opaque, wave-reflecting, and/or wave-absorbing materials. The body of the blocking member may be at least substantially elongated to define a blocking line or blocking direction which may be disposed at least substantially transverse to the target line or may be aligned so as to intersect the target line. The control member may include at least one actuator which may be arranged to effect a movement of the first blocking element along the elongated body to or toward the target point in a first direction at least substantially parallel with the blocking line. The actuator may be arranged to move the first blocking element in a second direction which is at least substantially transverse to the target line and blocking line. The blocking member may also include multiple first blocking elements arranged to be disposed at multiple preselected positions along the elongated body. The control member may include at least one actuator which is arranged to effect movement of at least one of the first blocking elements disposed at the target point in a third direction at least substantially transverse to the target and blocking lines. The first blocking elements may be arranged to be pivotally coupled to the elongated body between a non-blocking position and a blocking position, and the actuator may be arranged to pivotally rotate at least one of the first blocking elements disposed at the target point from the non-blocking position to the blocking position in the third direction and to keep the rest of the first blocking elements in the non-blocking position. In the alternative, the first blocking element may be arranged to be slidingly coupled to the elongated body in one of the non-blocking position and blocking position, and the actuator may be arranged to slidingly move or displace at least one of such first blocking elements disposed at the target point from the non-blocking position to the blocking position in the third direction and to keep the rest of the first blocking elements in the non-blocking position. Such a blocking member may include at least one guide which may be arranged to constrain movement of the first blocking elements therein or therearound.

The second blocking element may be arranged to be made of or include at least one substance which may have different molecular structures in the blocking and non-blocking states such that they exhibit different optical characteristics and, therefore, transmit different amounts of the waves or light rays in different states. When liquid crystals are employed as such a substance, the second blocking element may include a pair of polarizers and a pair of liquid crystal layers disposed therebetween as commonly seen in various conventional liquid crystal display devices. The second blocking element may also include multiple blocking cells arranged in a row, column, and/or array. Such blocking cells may be arranged to operate in at least one intermediate state in addition to the foregoing blocking and non-blocking states such that the cells in the intermediate state may transmit an amount of the waves which is generally greater than those by the cells in the blocking state but less than those by the cells in the non-blocking state. In such an embodiment, the control member may manipulate at least one of the blocking cells disposed in the target point to be in the blocking state and at least one of the blocking cells disposed near or around the target point to be in the intermediate state, while keeping the rest of the blocking cells in the non-blocking state.

The wave blocking system may include at least one energy source arranged to provide energy to the blocking and control members. When desirable, the sensor member may be arranged to provide at least a portion of the energy by supplying a portion of the electric signal generated in response to the waves or light rays.

In another aspect of the present invention, a method is provided to adaptively protect at least one target object from being directly illuminated by waves or light rays emitted by at least one wave source. Such a method may generally include the steps of receiving the waves emitted by the wave source, generating at least one signal in response to the waves, calculating a position of the wave source and/or target object at least substantially from the signal, determining at least one target point between the wave source and target object, and blocking at least a portion of the waves passing through the target point, thereby protecting the target object from being directly illuminated by at least a substantial portion of the waves which would otherwise have been received by the target object.

Embodiments of this aspect of the invention may include one or more of the following features.

The receiving step may include the step of receiving the waves in one or more preset angles. The generating step may include the step of generating electric current signal and/or optical signal in response to the waves. The obtaining step may also include the step of assessing the position of the wave source from the signal and assessing the position of the target object. The obtaining step may include the step of processing the signal generated at multiple different incident angles with respect to the wave source. The blocking step may include at least one of the steps of positioning at least one blocking element at the target point and manipulating transmittivity of the blocking element disposed at the target point.

In another aspect of the present invention, a wave blocking system may further be arranged to protect at least one target object from being directly illuminated by various waves irradiated by at least one wave source. The wave blocking system may include at least one sensor member, at least one blocking member, and at least one control member. The sensor member may receive the waves and generate at least one signal in response to the waves. The blocking member may include at least one body and at least one blocking element which may be movably coupled to the body and arranged to prevent at least a portion of the waves received thereby from transmitting therethrough. The control member may be arranged to receive the signal from the sensor member, to assess a position of the wave source and/or target object at least substantially based on the signal, to calculate a target point along a target line which may be determined from the positions of the wave source and target object, and to position at least a portion of such blocking elements at the target point, thereby protecting the target object from receiving at least a substantial position of the waves which would otherwise have been received by the target object.

In yet another aspect of the present invention, a wave blocking system may also be arranged to protect at least one target object from receiving waves emitted by at least one wave source. The wave blocking system may include at least one sensor member, at least one blocking member, and at least one control member. The sensor member may be arranged to receive the waves from the wave source and to generate at least one signal in response thereto. The blocking member may include at least one body and at least one blocking element fixedly coupled to the body and arranged to operate between a blocking state and a non-blocking state. The blocking element may generally be arranged to prevent at least a portion of the waves from transmitting therethrough in the blocking state and to transmit such a portion of the waves in the non-blocking state. The control member may be arranged to receive the signal, to assess a position of the wave source and/or target object from the signal, to assess a target point along a target line assessed from the positions of the wave source and target object, and to manipulate the blocking element disposed at the target point in the blocking state while keeping the rest of the blocking elements in the non-blocking state, thereby blocking the target object from receiving at least a substantial portion of the waves which would have otherwise been received by the target object.

In another aspect of the present invention, a wave blocking system may also be provided to be disposed between at least one wave source and at least one target object in order to protect such a target object from directly receiving waves emitted by the wave source. The wave blocking system includes at least one sensor member, at least one blocking member, and at least one control member. The sensor member may receive the waves emitted by the wave source and generate at least one signal in response thereto. The blocking member may include at least one blocking element operating between at least two different states including a non-blocking state and a blocking state such that the blocking element may be arranged to transmit at least a substantial portion of the waves therethrough in the non-blocking state and to block at least another portion of the waves in the blocking state. The control member may be arranged to be operatively coupled to the sensor and/or blocking members, to determine a two- or three-dimensional position of the wave source, and to position at least a portion of the blocking member at a target position disposed between the wave source and target object.

In yet another aspect of this invention, a wave blocking system may be capable of protecting at least one target object from directly receiving waves emitted by at least one wave source. Such a wave blocking system may include at least one sensor member, at least one blocking member, and at least one control member. The sensor member may be arranged to receive the waves from the wave source and to generate at least one signal in response to such waves. The blocking member may be arranged to be placed between the wave source and target object in order to block at least a portion of the waves received thereby. The control member may be arranged to receive the signal from the sensor member, to determine a position of the wave source and/or target object, to position at least a portion of the blocking member at a target position which is disposed between the wave source and target object, and to block at least a portion of the waves from transmitting through the portion of the blocking member.

In another aspect of the present invention, a wave blocking system may be provided so as to protect at least one target object from directly receiving waves emitted by at least one wave source. In one exemplary embodiment, a wave blocking system includes at least one blocking member and at least one control member. The blocking member may be arranged to define at least one blocking line or direction and to include a movable blocking element which may be arranged to move along such a blocking line or direction and to block at least a substantial portion of the waves received thereby from transmitting therethrough. The control member may be arranged to be operatively coupled to such a blocking member, to receive waves emitted by the wave source, to assess a position of the wave source emitting such waves, to assess a target line arranged to pass through the wave source and target object, to move at least a portion of the blocking element to a position which is disposed along the blocking line or direction and which may be nearest to the target line in order to block such waves from directly illuminating the target object while providing the target object with an optimum forward view with least obstruction. In another exemplary embodiment, a wave blocking system includes at least one blocking member and at least one control member. The blocking member may be arranged to define at least one blocking direction and to include multiple blocking elements which are arranged to move between at least one on-position and at least one off-position and to block at least a substantial portion of such waves received thereby from transmitting therethrough. The control member may be arranged to be operatively coupled to the blocking member, to receive waves emitted by the wave source, to assess a position of the wave source therefrom, to assess a target line arranged to pass through the wave source and target object, to move at least one of the blocking elements disposed within a preset distance from the target line from the off-position to the on-position so as to block the waves from directly illuminating the target object, and to keep the rest of the blocking elements in the off-position in order to provide an optimum forward view to the target object. In another exemplary embodiment, a wave blocking system includes at least one blocking member and at least one control member. The blocking member may include multiple blocking elements arranged to operate between at least one blocking state and at least one non-blocking state by changing their optical characteristics between such states, to prevent at least a substantial portion of the waves received thereby from transmitting therethrough in the blocking state, and to transmit such a substantial portion of the waves therethrough in the non-blocking state. The control member may be arranged to operatively couple with the blocking member, to receive waves emitted by the wave source, to assess a position of the wave source therefrom, to assess a target line which is arranged to pass through the wave source and target object, and to manipulate the optical characteristics of at least one of the blocking elements disposed within a preset distance from the target line to be in the blocking state in order to block such waves from directly illuminating the target object, while manipulating the optical characteristics of the rest of the blocking elements to be in the non-blocking state so as to provide an optimum forward view to the target object.

In another exemplary embodiment, such a wave blocking system includes at least one sensor member, at least one blocking member, and at least one control member. The sensor member may be arranged to receive waves emitted by the wave source and to generate at least one electric or optical signal in response thereto. The blocking member may be arranged to define at least one blocking line or direction and to include a movable blocking element arranged to move along the blocking line and to block at least a substantial portion of the waves received thereby from transmitting therethrough. The control member may then be arranged to be operatively coupled to the sensor and blocking members, to receive the signal from the sensor member, to assess a position of the wave source, to assess a target line arranged to pass through the wave source and target object, to move at least a portion of the blocking element to a position disposed along the blocking direction and nearest to the target line in order to block the waves from directly illuminating the target object, while providing the target object with an optimum forward view with least obstruction. In yet another exemplary embodiment, a wave blocking system includes at least one sensor member, at least one blocking member, and at least one control member. The sensor member may be arranged to receive waves emitted by the wave source and to generate at least one signal in response to the waves. The blocking member may be arranged to define at least one blocking direction and to include multiple blocking elements which are arranged to move between at least one on-position and at least one off-position and to block at least a portion of the waves received thereby from transmitting therethrough. The control member may be arranged to be operatively coupled to the sensor and blocking members, to receive the signal from the sensor member, to assess a position of the wave source, to assess a target line arranged to pass through the wave source and target object, and to move at least one of the blocking elements disposed within a preset distance from the target line from the off-position to the on-position so as to block the waves from directly illuminating the target object, while keeping the rest of the blocking elements in their off-position in order to provide an optimum forward view to the target object with least obstruction. In yet another exemplary embodiment, a wave blocking system may include at least one sensor member, at least one blocking member, and at least one control member. The sensor member may be arranged to receive waves emitted by the wave source and to generate at least one signal in response thereto. The blocking member may include multiple blocking elements which are arranged to operate between at least one blocking state and at least one non-blocking state by, e.g., changing at least one optical characteristic thereof between the states, to prevent at least a portion of the waves from transmitting therethrough in the blocking state, and then to transmit such a portion of the waves therethrough in the non-blocking state. The control member may similarly be arranged to be operatively coupled to the sensor and blocking members, to receive the signal from the sensor member, to assess a position of the wave source, to assess a target line arranged to pass through both the wave source and target object, and to manipulate the optical characteristics of at least one of the blocking elements disposed within a preset distance from the target line to be in the blocking state in order to block such waves from directly illuminating the target object while manipulating the optical characteristics of the rest of the blocking elements to be in the non-blocking state in order to provide an optimum forward view to the target object.

In another aspect of the present invention, a method may be provided to protect at least one target object from being illuminated by waves emitted by at least one wave source. One exemplary method may include the steps of assessing positions of the wave source and target object, disposing at least one blocking element between the wave source and target object, thereby protecting such a target object from being directly illuminated by the waves, tracking a change in the position of such a wave source with respect to the target object, and thereafter repeating the foregoing disposing the blocking element between the wave source and target object. Another exemplary method may also include the steps of disposing multiple blocking elements, assessing positions of the wave source and target object, changing optical properties of at least one of the blocking elements disposed between the wave source and target object in order to block such waves received thereby from transmitting therethrough, while keeping optical properties of the rest of the blocking elements in order to transmit the waves received thereby, tracking a change in the position of the wave source with respect to the target object, and repeating the foregoing changing and keeping steps, thereby protecting the target object from being directly illuminated by the waves. Another exemplary method may also include the steps of assessing a position of the target object, generating at least one electric signal and/or optical signal in response to the waves, assessing a position of the wave source at least partially based on the signal, disposing at least one blocking element between the wave source and target object so as to protect the target object from being directly illuminated from such waves, tracking a change in the position of the wave source with respect to the target object, and repeating the foregoing disposing the blocking element between the wave source and target object. Yet another exemplary method may include the steps of disposing multiple blocking elements horizontally or vertically, assessing a position of the target object, generating at least one of an electric signal and optical signal in response to such waves, assessing a position of the wave source at least partially based on such a signal, changing optical properties of at least one of such blocking elements disposed between the wave source and target object so as to block the waves received thereby from transmitting therethrough, while keeping optical properties of the rest of the blocking elements to transmit the waves received thereby, tracking a change in the position of the wave source with respect to the target object, and repeating the above changing and keeping steps, thereby protecting the target object from being directly illuminated by the waves.

As used herein, the term “target point” generally refers to a point defined in a two-dimensional plane and/or in a three-dimensional space and disposed between a wave source and a target object. Depending upon a size of the target object, however, the “target point” may be used interchangeably with a “target range” defined in the two-dimensional plane and/or a three-dimensional space as well.

The terms “sensor member,” “sensor unit,” and “sensor” are generally used in a hierarchy so that a “sensor member” may include at least one “sensor unit” and/or “sensor” therein, and a “sensor unit” may include at least one ‘sensor’ therein. Accordingly, it is understood that each of the “sensor member” and “sensor unit” generally includes at least one “sensor” therein.

A “target object” generally means an operator or a driver of various vehicles, equipment, and instruments as described herein. It is appreciated, however, that the “target object” may also include any non-human instruments and/or parts thereof when such instruments and/or their parts may have to be protected from being directly illuminated by such waves.

Unless otherwise defined in the following specification, all technical and scientific terms used herein have the same meaning as commonly understood by one of ordinary skill in the art to which the present invention belongs. Although the methods or materials equivalent or similar to those described herein can be used in the practice or in the testing of the present invention, the suitable methods and materials are described below. All publications, patent applications, patents, and/or other references mentioned herein are incorporated by reference in their entirety. In case of any conflict, the present specification, including definitions, will control. In addition, the materials, methods, and examples are illustrative only and not intended to be limiting.

Other features and/or advantages of the present invention will be apparent from the following detailed description and from the claims.

### BRIEF DESCRIPTION OF THE DRAWING

FIG. 1 is a schematic diagram of an exemplary wave blocking system according to the present invention;

FIG. 2 is a cross-sectional view of an exemplary sensor member of a wave blocking system according to the present invention;

FIG. 3 is a schematic cross-sectional view of an exemplary wave blocking system including a wave source and a target object on a x-y plane for determining a target point according to the present invention;

FIG. 4 is a perspective view of another exemplary sensor member of a wave blocking system according to the present invention;

FIG. 5 is a perspective view of another exemplary sensor member of a wave blocking system according to the present invention;

FIG. 6 is a perspective view of an exemplary rotatable or movable sensor member of a wave blocking system according to the present invention;

FIG. 7 is a perspective view of an exemplary sensor member including a rotatable or movable wave reflector of a wave blocking system according to the present invention;

FIG. 8 is a schematic diagram of yet another exemplary wave blocking system according to the present invention;

FIG. 9 is a schematic diagram of yet another exemplary wave blocking system according to the present invention;

FIGS. 10 to 12 are schematic diagrams of other exemplary wave blocking systems according to the present invention; and

FIGS. 13 and 14 are schematic views of further exemplary sensor members of wave blocking systems according to the present invention.

### DETAILED DESCRIPTION OF THE PREFERRED EMBODIMENTS

The wave blocking systems and methods therefor of the present invention may be arranged to at least substantially block transmission of various acoustic or electromagnetic waves toward at least one target object. More particularly, the wave blocking systems and methods related thereto may be arranged to prevent drivers or operators of various transportation, construction, medical or scientific equipment or instruments from being directly irradiated or illuminated by hazardous, harmful or irritating waves. When such wave blocking systems and methods are used for various land, air, surface, and space transportation vehicles such as, e.g., automobiles, motorcycles, bicycles, airplanes, ships, and the like, the drivers or operators thereof may enjoy satisfactory forward views even when they have to operate such vehicles while directly staring in a direction of the sun during the daytime or directly being illuminated by headlights of oncoming vehicles and street lights during the night time. Various wave blocking systems and methods therefor of this invention may also be applied when the wave source may be either stationary or mobile, when the target object may be either stationary or mobile, and the like.

Various exemplary aspects and embodiments of wave blocking systems and methods therefor of the present invention will now be described more particularly with reference to the accompanying drawings and/or text, where such aspects and embodiments may only represent different forms. The wave blocking systems and methods therefor of the present invention, however, may be embodied in many other different forms and, therefore, should not be limited to such aspects and embodiments set forth herein. Rather, various exemplary aspects and embodiments described herein are provided so that this disclosure will be thorough and complete and fully convey the scope of the present invention to one skilled in the relevant art.

Unless otherwise specified, it is to be understood that various members, elements, units, and parts of the wave blocking systems are not generally drawn to scales and/or proportions for ease of illustration. It is also understood that the members, elements, units, and/or parts of the wave blocking systems designated by the same numerals generally represent the same, similar, and/or functionally equivalent members, elements, units, and/or parts thereof, respectively.

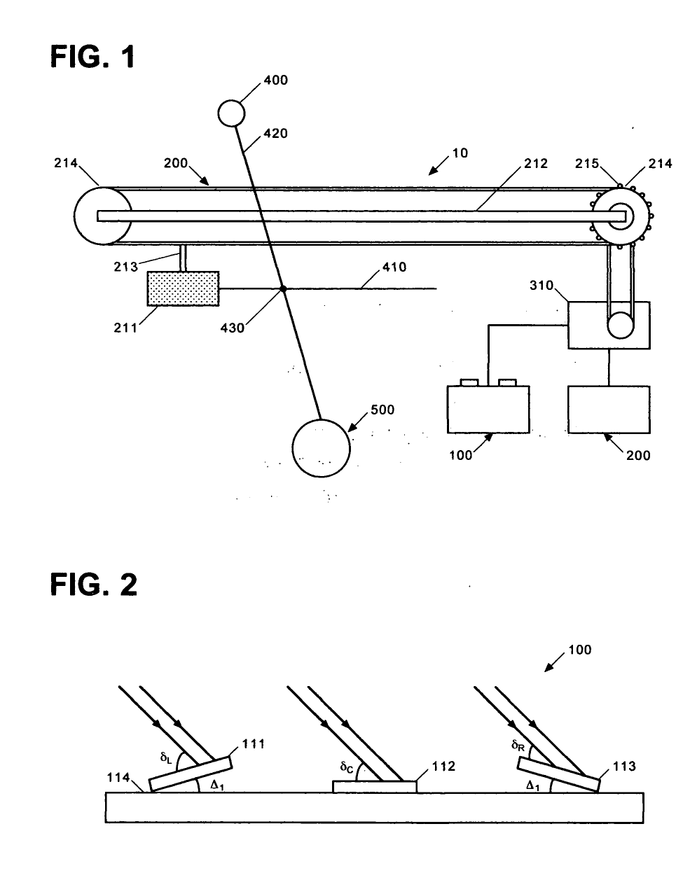

In one aspect of this invention, at least one blocking element may be arranged to be movably disposed at a target point along a blocking line and to block at least a substantial part of such waves from transmitting therethrough. Such an embodiment may allow proper positioning of such a blocking element only at an intervening target point between at least one wave source and at least one target object. FIG. 1 is a schematic diagram of an exemplary wave blocking system according to the present invention. In this exemplary aspect of the present invention, a wave blocking system 10 may be used to block light rays, electromagnetic waves, acoustic waves and lasers irradiated, emanated, and/or emitted by a wave source 400 from being directly transmitted or impinged on a target object 500 such as, e.g., a driver of an automobile, an operator of construction equipment, a technician operating an optical or medical instrument, and the like. The wave blocking system 10 typically includes a sensor member 100, a blocking member 200, and a control member 300.

The sensor member 100 may generally be arranged to receive at least a first portion of such waves irradiated by the wave source 400 and to generate at least one electric and/or optical signal in response to such waves. Any conventional light-sensitive or sound-sensitive sensing elements may be used as or included in the sensor member 100 as long as such sensors may generate electrical or optical signals of which their amplitudes, frequencies, phase angles, wavelengths, harmonics, and/or other time- or frequency-domain parameters may be determined according to and/or may be a function of, e.g., a two- and/or three-dimensional location of the wave source 400, a distance from the wave source 400 thereto, a two- and/or three-dimensional incident angle between the sensors and waves, an extent of surface absorption and/or reflection of the waves by such sensors, and the like. More particular examples of the light-sensitive sensors may include, but not be limited to, photovoltaic cells and/or units such as conventional solar cells, photodetectors such as charge-coupled devices, and the like. More particular examples of the sound-sensitive sensors may also include, but not be limited to, conventional microphones, acoustic wave transducers, and the like.

The blocking member 200 may include at least one blocking element such as a light blocker or a wave blocker 211, at least one body with a preset shape such as a guide 212, at least one connector 213, and so on. The wave blocker 211 is arranged to receive a second portion of the electromagnetic or acoustic waves irradiated or emitted by the wave source 400 and is generally composed of, e.g., opaque, semi-opaque, semi-transparent, translucent, reflective, and/or light-absorbing material so as to block at least a part of the second portion of the waves from transmitting therethrough. Exemplary materials of the blocker 211 may include, but not be limited to, conventional wave reflecting materials, wave refracting materials, wave absorbing materials, and so on. The guide 212 is generally arranged to extend along a curvilinear (i.e., straight and/or curved) blocking direction or blocking line 400 which is selected to be preferably transverse to a two- and/or three-dimensional curvilinear target line 420 arranged to pass through the wave source 400 and target object 500 or vice versa. The connector 213 may be generally arranged to support the blocker 211 and to movably couple with the fixed guide 212 or to fixedly couple with the movable guide 212 such that the blocker 211 is translated or moved with respect to the wave source 400 and/or target object 500 along the guide 212 along the blocking direction or blocking line 410.

The control member 300 is operationally coupled to the sensor member 100 in order to receive the electrical and/or optical signal generated thereby. As will be described in greater detail below, the control member 300 may be arranged to calculate the location of the wave source 400 based at least partially on the signal generated by the sensor member 400, to obtain a two- and/or three-dimensional curvilinear target line 420 based on the locations of the wave source 400 and target object 500, and to assess a target point 430 which generally corresponds to a two- and/or three-dimensional point of intersection 430 between the blocking line 410 and target line 420. The control member 300 may also include at least one actuator 310 arranged to manipulate the connector 212 and/or movable guide 213 in such a way that the blocker 211 may be disposed at the target point 430 and block the target object 500 from being impinged by at least a substantial portion of the second portion of the waves.

Movements of the blocker 211 of the blocking member 200 may be realized based on various embodiments. For example and as shown in the figure, the blocker 211 may be fixedly and rotatably coupled to the connector 213 which is in turn fixedly or rotatably coupled to the guide 212 comprising a belt and/or a chain fitted snugly around two wheels 214 at least one of which may be threaded or include optional teeth 215. By arranging the actuator 310 to rotate at least one of such wheels 214, the connector 213 may be translated at least substantially horizontally or laterally along the blocking line or direction 410 to position the blocker 211 at the target point 430. Alternatively, the blocker 211 may be fixedly or rotatably coupled to the connector 213 which is in turn movably or slidingly coupled to the guide 212. In this embodiment, the connector 213 and guide 212 are typically arranged to form a conventional rack and pinion gear assembly or worm and pinion gear assembly such that rotation of a guide 212 may translate the connector 213 and blocker 211 coupled thereto. Other embodiments may also be used as long as the actuator 310 may manipulate the blocking member 200 to position at least a portion of the blocker 211 at the desired target point 430.

The location of the wave source 400 may be assessed with respect to numerous reference points such as, e.g., locations of the sensor member 100, blocking member 200, control member 300, target object 500, and the like. When desirable, locations inside the vehicles and/or parts thereof may also be selected as the target point 430 and/or reference points. Following is an exemplary algorithm arranged to determine the position of the wave source 400 with respect to the sensor member 100.

FIG. 2 is a cross-sectional view of an exemplary sensor member of a wave blocking system according to the present invention, where the wave source 400 such as, e.g., the sun is assumed to be located far away from the sensor member 100 and, accordingly, to emit substantially parallel light rays onto the sensor member 100 and target object 500 at an identical angle. The sensor member 100 may preferably include three light-sensitive sensing elements such as a left sensor 111 represented by a subscript L, a center sensor 112 represented by a subscript C, and a right sensor 111 denoted by a subscript R. All sensors 111-113 may be disposed over a base 114 of the sensor member 110 and arranged to receive the parallel waves, more particularly, light rays emanating from a single light source (not shown in the figure). In addition, at least two of the sensors 111-113 may be preferably arranged to be disposed on the base 114 forming at least two different tilt angles and to receive such light rays at different incident angles. Although all of the sensors 111-113 may be disposed to have mutually different and independent tilt angles, the embodiment shown in FIG. 2 arranges the sensors 111-113 on the base 114 to respectively form only two independent tilt angles such as Δ₁ or (π−Δ₁) radians and 0 radian in order to simplify the derivation of an exemplary control algorithm for the control member 300. Using such angles and assuming that the sensors 111-113 are arranged to receive the waves by their flat, top sensing surfaces, following relationships may be obtained:
δ_{L}=δ_{C}+Δ₁ (1-1)
δ_{R}=δ_{C}−Δ₁ (1-2)

When the sensors 111-113 have at least substantially identical cross-sectional areas and the wave source 400 is disposed from the sensors 111-113 at a distance which is at least a few orders of magnitudes greater than the lengths of the base 114 and sensors 111-113 so that distances from the wave source 400 to each sensor 111-113 may be deemed to be at least substantially identical, an intensity of each signal generated by each sensor 111-113 such as electric voltage or current may be dependent at least substantially upon the incident angles of the waves with respect to each sensor 111-113 such that:
I_{L}=f(δ_{C}) (1-3)
I_{C}=f(δ_{C}) (14)
I_{R}=f(δ_{R}) (1-5)
where “I_{L},” “I_{C},” and “I_{R}” represent electric currents generated by the left, center, and right sensors 111-113, respectively, where “I_{L},” “I_{C},” and “I_{R}” are incident angles of the waves with respect to the left, center, and right sensors 111-113, respectively, and where “f” denotes a transfer function for a relationship between input variables (such as the incident angles of the waves) and output variables (such as the electric current or voltage generated by the sensors 111-113). When the sensors 111-113 are at least substantially identical photovoltaic cells, the electric currents generated thereby may be represented as:
I_{L}=α₁ cos(δ_{L}) (1-6)
I_{C}=α₂ cos(δ_{C}) (1-7)
I_{R}=α₃ cos(δ_{R}) (1-8)
where “α₁,” “α₂,” and “α₃” are proportionality constants denoting photovoltaic characteristics of such sensors 111-113, respectively.

Based on such electric currents and/or other signals generated by the sensors 111-113 of the sensor member 110, the control member 300 may first determine on which side of the x-y plane such a wave source 400 is located. For example, when the electric current generated by the left sensor 111 is greater than that generated by the right sensor 113, the wave source 400 may be deemed to be located on the left side of the x-y plane with respect to the center sensor 112. When the electric currents generated by the left and right sensors 111, 113 are substantially identical and/or when the current generated by the center sensor 112 is the greatest or far greater than other currents, such a wave source 400 may be deemed to be located on a plane having an incident angle of π/2 radian with the center sensor 112. In contrary, when the electric current generated by the left sensor 111 is less than that generated by the right sensor 113, such a wave source 400 may be deemed to be located on the right side of the x-y plane with respect to the center sensor 112. The control member 300 may then calculate the incident angles from the equations (1-6) to (1-8) such that:
δ_{L}=cos⁻¹(I_{L}/α₁) (1-9)
δ_{C}=cos⁻¹(I_{C}/α₂) (1-10)
δ_{R}=cos⁻¹(I_{R}/α₃) (1-11)
The proportionality constants “α₁,” “α₂,” and “α₃” may be easily obtained from a supplier thereof as at least one constant or characteristic curve which may be a function of incident angles and intensities of the waves. Alternatively, the proportionality constants may be obtained from separate calibration experiments as well. However, the sensors 111-113 such as photovoltaic cells or solar cells usually go through normal wear and tear or degrade over time. For example, such sensors 111-113 may be externally disposed and directly exposed to the sunlight and outside weather such as rain and snow. They may be covered by dust and/or degraded by ultraviolet rays evenly or, most probably, unevenly. Although identical sensors 111-113 may be used, there may exist idiosyncratic differences in each of the sensors 111-113 such that a single proportionality constant or a single calibration curve may not prove satisfactory. In addition, wide ranges of temperature and/or humidity may drive the operational characteristics of the sensors 111-113 off the calibrated ranges of operations thereof. Accordingly, instead of relying on less accurate and reliable methods employing such proportionality constants “α₁,” “α₂,” and “α₃,” foregoing incident angles, “δ_{L},” “δ_{C},” and “δ_{R}” may be calculated by other methods. For example, assuming that the proportional constants are substantially identical, such constants may be eliminated by taking ratios of the equations (1-6) through (1-8), and possible heterogeneity in the value of the constants may be canceled out such that:
I_{L}=α₁ cos(δ_{L})=α₁ cos(δ_{C}+Δ₁) (1-12)°
I_{C}=α₂ cos(δ_{C}) (1-7)
I_{L}/I_{C}=α₁ cos(δ_{C}+Δ₁)/α₂ cos(δ_{C})≈cos(δ_{C}+Δ₁)/cos(δ_{C}) (1-13)
By rearranging the above equation (1-13) and using the relationships of the equations (1-1) and (1-2), the incident angles “δ_{L},” “δ_{C},” and “δ_{R}” may be obtained in terms of the electric currents “I_{L},” “I_{C},” and “I_{R}” such that:
(I_{L}/I_{C})cos(δ_{C})=cos(δ_{C}+Δ₁)=cos(δ_{C})cos(Δ₁)−sin(δ_{C})sin(Δ₁)
sin(δ_{C})sin(Δ₁)={cos(Δ₁)−(I_{L}/I_{C})}cos(δ_{C})
sin(δ_{C})/cos(δ_{C})=tan(δ_{C})={cos(Δ₁)−(I_{L}/I_{C})}/sin(Δ₁)
δ_{C}=tan⁻¹[{cos(Δ₁)−(I_{L}/I_{C})}/sin(Δ₁)] (1-14)
δ_{L}=δ_{C}+Δ₁=tan⁻¹[{cos(Δ₁)−(I_{L}/I_{C})}/sin(Δ₁)]+Δ₁ (1-15)
δ_{R}=δ_{C}−Δ₁=tan⁻¹[{cos(Δ₁)−(I_{L}/I_{C})}/sin(Δ₁)]−Δ₁ (1-16)
That is, the incident angles “δ_{L},” “δ_{C},” and “δ_{C}” may be calculated in terms of the above electric currents “I_{L},” “I_{C},” and “I_{R}” and the tilt angles of the sensors 111-113, Δ₁ or (π−Δ₁) all of which may be readily measurable. As shown by the equations (1-14) to (1-16), only two sensors are theoretically required to obtain the foregoing three incident angles. Thus, the same incident angles may also be obtained in terms of another pair of the electric currents “I_{C}” and “I_{R}” by taking another ratio of “I_{C}” to “I_{R}” or yet another pair of currents “I_{L}” and “I_{R}” by taking another ratio of “I_{L}” to “I_{R}” such that:
I_{C}/I_{R}=α₂ cos(δ_{C})/α₃ cos(δ_{C}−Δ₁)≈cos(δ_{C})/cos(δ_{C}−Δ₁)
(I_{R}/I_{C})cos(δ_{C})=cos(δ_{C}−Δ₁)=cos(δ_{C})cos(Δ₁)+sin(δ_{C})sin(Δ₁)
sin(δ_{C}) sin(Δ₁)={(I_{R}/I_{C})−cos(Δ₁)}cos(δ_{C})
sin(δ_{C})/cos(δ_{C})=tan(δ_{C})={(I_{R}/I_{C})−cos(Δ₁)}/sin(Δ₁)
δ_{C}=tan⁻¹[(I_{R}/I_{C})−{cos(Δ₁)}/sin(Δ₁)] (1-17)
δ_{L}=δ_{C}+Δ₁=tan⁻¹[{(I_{R}/I_{C})−cos(Δ₁)}/sin(Δ₁)]+Δ₁ (1-18)
δ_{R}=δ_{C}−Δ₁=tan⁻¹[(I_{R}/I_{C})−{cos(Δ₁)}/sin(Δ₁)]−Δ₁ (1-19)
I_{L}/I_{R}=α₁ cos(δ_{C}+Δ₁)/α₃ cos(δ_{C}−Δ₁)≈cos(δ_{C}+Δ₁)/cos(δ_{C}−Δ₁)
(I_{L}/I_{R})cos(δ_{C}−Δ₁)=cos(δ_{C}+Δ₁)
(I_{L}/I_{R}){cos(δ_{C})cos(Δ₁)+sin(δ_{C}) sin(Δ₁)}=cos(δ_{C})cos(Δ₁)−sin(δ_{C}) sin(Δ₁)
(I_{L}/I_{R})cos(δ_{C})cos(Δ₁)+(I_{L}/I_{R})sin(δ_{C})sin(Δ₁)=cos(δ_{C})cos(Δ₁)−sin(δ_{C})sin(Δ₁)
(I_{L}/I_{R})cos(δ_{C})cos(Δ₁)−cos(δ_{C})cos(Δ₁)=−(I_{L}/I_{R})sin(δ_{C}) sin(Δ₁)−sin(δ_{C})sin(Δ₁)
{1−(I_{L}/I_{R})}cos(δ_{C})cos(Δ₁)={(I_{L}/I_{R})+1}sin(δ_{C})sin(Δ₁)
{1−(I_{L}/I_{R})}={(I_{L}/I_{R})+1}tan(δ_{C})tan(Δ₁)
tan(δ_{C})={1−(I_{L}/I_{R})}/{1+(I_{L}/I_{R})}tan(Δ₁)
δ_{C}=tan⁻¹[{1−(I_{L}/I_{R})}/{1+(I_{L}/I_{R})}tan(Δ₁)] (1-20)
δ_{L}=δ_{C}+Δ₁=tan⁻¹[{1−(I_{L}/I_{R})}/{1+(I_{L}/I_{R})}tan(Δ₁)]+Δ₁ (1-21)
δ_{R}=δ_{C}−Δ₁=tan⁻¹[{1−(I_{L}/I_{R})}/{1+(I_{L}/I_{R})}tan(Δ₁)]−Δ₁ (1-22)
When multiple estimates of the incident angles, “δ_{L},” “δ_{C},” and “δ_{R},” are obtained and their values are not identical, at least some of the estimates may be arithmetically, geometrically or weight averaged so as to yield averaged estimates of such angles, thereby enhancing the accuracy and reliability thereof.

It is appreciated that the incident angles shown in the figure do not necessarily correspond to the three-dimensional incident angles actually formed between the sensing elements 111-113 of the sensor member 100 and the waves illuminated or impinged thereupon in the three-dimensional space. Rather, the foregoing incident angles, “δ_{L},” “δ_{C},” and “δ_{R},” may only denote two-dimensional projections of the three-dimensional angles as projected, e.g., on the x-y plane. Whether the control member 300 needs to calculate two- or three-dimensional locations of the wave source 400 and/or target object 500 may generally depend upon whether the blocking member 200 needs to block the waves in, e.g., one- or two-dimension, respectively. Because the blocking element such as the blocker 111 of the blocking member 200 of FIG. 2 is arranged to move in only one dimension, the control member 300 of such an embodiment may only need to obtain the two-dimensional position of the wave source 400 or target object 500. As will be described in greater detail below, these embodiments may be applicable to the sensors 111-113 disposed in any tilt angles with respect to x- or y-axis, although such sensors 111-113 may preferably have identical tilt angles with respect to a third axis which is normal to the x- or y-axis such as, e.g., the z-axis. In addition and as described above, the control member 300 may be arranged to receive the electric signals from the sensor member 100 and to obtain their ratios. In the alternative, the sensor member 100 may be arranged to electrically generate the signals denoting the ratios of the electric signals and the control member 300 may receive the ratios directly from the sensor member 100.

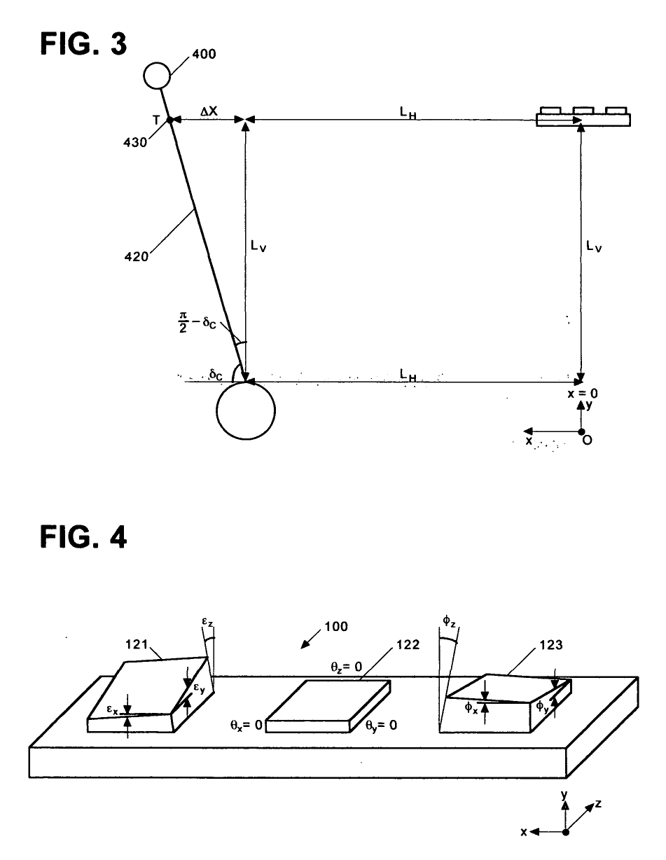

FIG. 3 is a schematic cross-sectional view of an exemplary wave blocking system including a wave source and a target object on a x-y plane for determining a target point according to the present invention. An exemplary wave blocking system 10 of this embodiment includes a sensor member 100 which is similar to that of FIG. 1 which incorporates three sensing elements 111-113, and an actuator (not shown in this figure) of the control member 300 which may be arranged to displace at least one blocking element such as a blocker 211 of the blocking member 200 which is in turn arranged to move in one dimension such as, e.g., horizontally with respect to the target object 500 or longitudinally along an axial direction of a body such as the guide 212. By disposing the vase 114 of the sensor member 100 to be in parallel with a preset portion of the target object 500 such as, e.g., eyes of a driver or an operator of various vehicles, equipment, and instruments, an incident angle between the eyes and the waves may become at least substantially identical to the incident angle of the center sensor 112, i.e., “δ_{C}.” In addition, by arranging the guide 212 of the blocking member 200 at least substantially parallel with a line which connects the eyes of the driver or operator, the blocker 211 of the blocking member 200 may move along a blocking line or direction 410 which is typically transverse to the target line 420 and intersects therewith at the target point 430. Using such configurations, a trigonometric equates the incident angle, “δ_{C},” with various distances such that:
tan(π/2−δ_{C})=ΔX/L_{V} (1-23)
where “ΔX” represents a horizontal distance from the target point to a center point between the eyes along the x-axis and “L_{V}” is a vertical distance from the center of the eyes to the blocking direction 410 along the y-axis. By rearranging the above equation, the axial distance, “ΔX,” may be calculated as follows:
ΔX=L_{V} tan(π/2−δ_{C}) (1-24)
By defining another variable, “L_{H},” as a horizontal distance from a center of the sensor member 100 or base 114 to the center of the eyes along the x-axis, a distance between the target point 430 and the center sensor 112 or the center of the base 114, “L_{T},” may be expressed as:
L_{T}=ΔX+L_{H}=L_{V} tan(π/2−δ_{C})+L_{H} (1-25)

In operation, when the wave blocking system 10 of the present invention based on the above embodiment may be applied to protect the driver and/or operator from being irradiated by the sunlight, the sensor member 100 may be fixedly disposed in any desirable locations, e.g., on or beneath a front windshield or on a front part of a body of the vehicle, which may be easily illuminated by the sunlight, street lights, headlights of other vehicles, and/or other sources of various waves. In this embodiment, coordinate values of the sensors 111-113 of the sensor member 110 may be expressed with respect to a reference point such as the origin, “0” shown in FIG. 3, in the three-dimensional space and/or in two-dimensional cross-sections thereof such as the x-y plane. Because a seat of the driver 500 of the vehicle is rather stationary and because a location of the driver 500 and coordinate values thereof with respect to the origin are rather fixed, the foregoing distances such as “L_{H}” and “L_{V}” may readily be obtained. When the waves or light rays illuminate the sensors 111-113 of the sensor member 100 and when the sensors 111-113 generate analog or digital electric and/or optical signals, the control member 300 calculates the location of the target point 430 along the blocking direction 410 denoted by the equation (1-25). The actuator 310 of the control member 300 then linearly translates or otherwise moves the blocker 211 of the blocking member 200 to or toward the target point 430, thereby at least partially blocking the sunlight from impinging directly upon the eyes of the driver or operator 500.

It is appreciated that the above equation (1-19) may also be modified according to the relative location of the wave source 400 with respect to the center of the eyes of the driver or operator 500. For example, when the wave source 400 is disposed on the right side of the center of the eyes, the equation (1-19) may be modified as follows:
L_{T}=L_{H}−ΔX=L_{H}−L_{V} tan(π/2−δ_{C}) (1-26)
As described above, selection between the equations (1-25) and (1-26) may be made rather easily, e.g., by determining whether the wave source 400 is located on the left or right side of such a center sensor 211. Alternatively, the equation (1-25) may always be used regardless of the actual position of the wave source 400 with respect to the center sensor 112 when the angle, “δ_{C},” may be defined to have any value between 0 and 2π radians or when vectors may be used as the foregoing system variables to yield vector equations instead of the foregoing scalar equations.

It is also appreciated that the above embodiments of FIGS. 1 to 3 are preferably applied to any sensor members having any sensors and/or sensing elements arranged to form at least substantially identical tilt angles with respect to a third axis of a three-dimensional coordinate system such as a z-axis normal to the x- and y-axes. When the waves irradiated by the wave source 400 illuminate, e.g., sensing surfaces of the sensors 111-113 of the sensor member 100 shown in FIG. 3, the x-, y-, and z-components of such waves would impinge upon the sensing surfaces of the sensors 111-113 at mutually different incident angles. Although the x- and y-components may be taken into account by various incident angles shown in FIG. 3, the z-components are generally not accounted for in such an analysis. Therefore, in order to apply the above two-dimensional algorithm, each sensor 111-113 may preferably be arranged to form identical tilt angles along the third axis such as the z-axis such that the z-components of the waves or light rays do not have to unevenly affect the electric currents and/or voltage generated by the sensors 111-113.

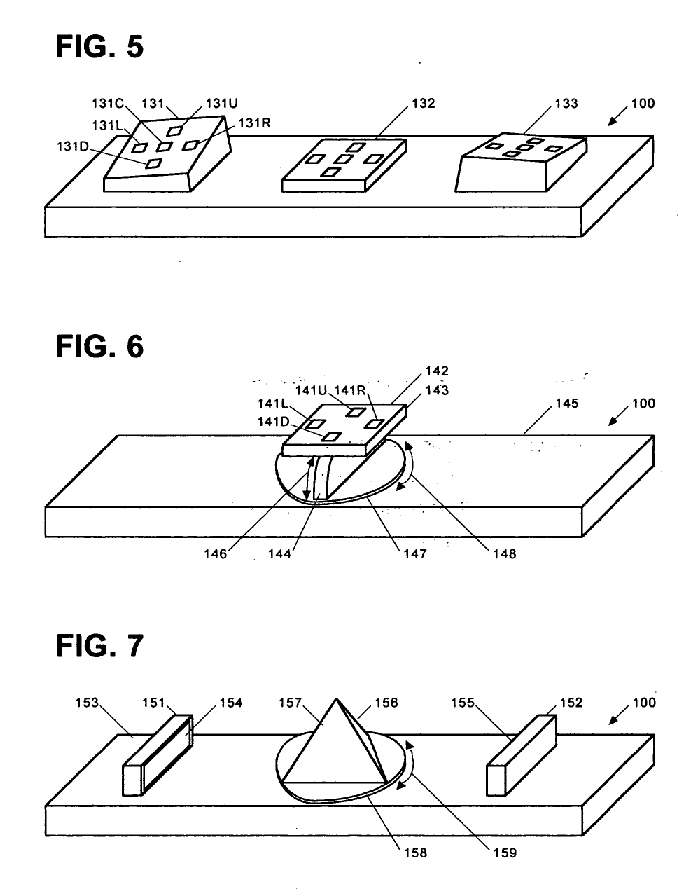

As discussed above, the embodiment of FIG. 3 allows one-dimensional translation of at least one blocking element such as the blocker 211 of the blocking member 200 along the body such as the guide 212 along the blocking line or direction 410. Therefore, the control member 300 may only have to calculate the target point 430 as a point of intersection between the blocking direction 410 and the target line 420 and then to manipulate the actuator 310 in order to move the blocker 211 to or toward the target point 430 along the guide 212 in the blocking line or direction 410. However, when such an actuator 310 is arranged to translate, rotate, and/or otherwise move the blocker 211 along at least one additional direction which is different from the blocking direction 410, the control member 300 may be arranged to calculate three-dimensional positions of the target object 500 and target point 430, and to move the blocker 211 to or toward the target point 430. Numerous different embodiments may also be used to obtain the three-dimensional coordinate values of the target object 500 and target point 430. For example, in addition to the first target line 420 on the x-y cross-section, a second target line may be calculated on another cross-section on the y-z or x-z plane by applying similar algorithm to such a cross-section and then by solving equations derived therefrom. Using the first target line 420, a first target plane may be obtained which is normal to the x-y plane and passes through the first target line 420. Similarly, a second target line may also be obtained which is normal to the y-z or x-z plane and passes through the second target line. By obtaining a line of intersection between the above first and second target planes, both of the target line and target point may be calculated in a three-dimensional space. Therefore, this embodiment offers the benefit of obtaining the coordinate values of the three-dimensional target point using any sensor members including any number of sensors disposed and/or arranged in almost any arbitrary configurations, e.g., such as those described in FIGS. 1 through 3. In the alternative, a sensor member may be arranged to have multiple sensors at least two of which are arranged to form different tilt angles with respect to the x-y, y-z, and/or x-z planes. Following FIGS. 4 and 5 illustrate exemplary embodiments of such sensor members.

Accordingly, in another aspect of the present invention, multiple sensing elements or sensors of such a sensor member may be arranged to receive the waves and/or light rays at different incident angles in three dimensions. FIG. 4 is a perspective view of another exemplary sensor member of a wave blocking system according to the present invention, where a sensor member 100 includes a left sensor 121, a center sensor 122, and a right sensor 123 disposed on a base 124 thereof. The center sensor 122 may generally be disposed over the base 124 with its top sensing surface parallel with a top surface of the base 124. Therefore, the center sensor 122 forms three tilt angles, “θ_{X},” “θ_{Y},” and “θ_{Z},” of 0 radian with respect to the x-, y- and z-axis, respectively. In contrary, the left sensor 121 is disposed on the base 124 to have its top sensing surface to form three nonzero tilt angles, “ε_{X},” “ε_{Y},” and “ε_{Z},” with respect to the x-, y-, and z-axis, while the right sensor 123 is also disposed over the base 124 to form three nonzero tilt angles, “φ_{X},” “φ_{Y},” and “φ_{Z},” with respect to the x-, y-, and z-axis, respectively. Using the foregoing tilt angles, the embodiment of FIG. 3 corresponds to the case where the tilt angles, “ε_{Y},” “ε_{Z},” “θ_{X},” “θ_{Y},” “θ_{Z},” “φ_{Y},” and “φ_{Z},” are all zero.

When the sensors 111-113 are disposed according to the above configuration and arranged to have at least substantially identical cross-sectional areas, such sensors 111-113 may generate the electric and/or optical signals intensities of which generally depend at least substantially upon three-dimensional incident angles of the waves with respect to each sensor 111-113 such that:
I_{L}=α₁g(Ψ_{L})=α₁ cos(Ψ_{L}) (2-1)
I_{C}=α₂g(Ψ_{C})=α₂ cos(Ψ_{C}) (2-2)
I_{R}=α₃g(Ψ_{R})=α₃ cos(Ψ_{R}) (2-3)
where “I_{L},” “I_{C},” and “I_{R}” represent electric currents generated by the left, center, and right sensors 121-123, respectively, where “Ψ_{L},” “Ψ_{C},” and “Ψ_{R}” are respectively three-dimensional incident angles of the waves with respect to sensing surfaces of the left, center, and right sensors 121-123 such as those angles formed between the light rays and their projections made at right angles on the sensing surfaces of such sensors 121-123. In addition, “g” is a transfer function for a relationship between various input (and/or optional) variables and output variables, where examples of such input variables may include three-dimensional incident angles of the waves, where examples of the optional variables may include intensities of the waves, areas of the sensing surfaces of the sensors 121-123, and the like, and where examples of the output variables may include the electric current or voltage generated by the sensors 121-123. Moreover, “α₁,” “α₂,” and “α₃” respectively denote proportionality constants for the photovoltaic characteristics of such sensors 121-123. By rearranging the above equations, the three-dimensional incident angles may be expressed as follows:
Ψ_{L}=cos⁻¹[I_{L}/α₁] (2-4)
Ψ_{C}=cos⁻¹[I_{C}/α₂] (2-5)
Ψ_{R}=cos⁻¹[I_{R}/α₃] (2-6)
As discussed above, such proportionality constants “α₁,” “α₂,” and “α₃” may be obtained by various aforementioned methods and the three-dimensional incident angles may be obtained therefrom. In the alternative, the proportionality constants may be eliminated from the equations by taking ratios of the above equations (2-4) to (2-6) such that:
I_{L}/I_{C}=cos(Ψ_{L})/cos(Ψ_{C}) (2-7)
I_{c}/I_{R}=cos(Ψ_{C})/cos(Ψ_{R}) (2-8)
I_{R}/I_{L}=cos(Ψ_{R})/cos(Ψ_{L}) (2-9)

As is the case with the exemplary embodiment of FIG. 3, knowledge of at east one of the three incident angles, “Ψ_{L},” “Ψ_{C},” and “Ψ_{R},” allows calculation of a three-dimensional incident angle between the wave source 400 and target object 500. From the known position of the target object 500 and/or a region in which the target object 500 is positioned, the target line 420 connecting the wave source 400 and target object 500 may readily be obtained as a line passing through the position and/or range of the target object 500 at the foregoing three-dimensional incident angle. It is appreciated, however, that above three equations (2-7) to (2-9) may not necessarily provide three incident angles, because one of the above three equations (2-7) to (2-9) is not independent, i.e., one equation may be derived from the other two equations. Various algorithms may be employed to obtain at least one of the above incident angles in conjunction with at least two of the equations (2-7) to (2-9).

First, at least two of the incident angles, “Ψ_{L},” “Ψ_{C},” and “Ψ_{R},” may be arranged to depend upon each other such that two of the equations (2-7) to (2-9) become independent and are solved for two independent incident angles as well as one dependent incident angle. For example, the left and right sensors 121, 123 may have various exemplary tilt angles related to each other such as:
ε_{Y}=ε_{Z}=θ_{X}=θ_{Y}=θ_{Z}=φ_{Y}=φ_{Z}=0 (2-10)
0<ε_{X}=φ_{X}<π/2 (2-11)
When the incident angles are defined in vectors, the equation (2-11) relating the scalar angles may be modified to relate the tilt angles “_{X}” and “ε_{X}” defined in opposite directions such that:
ε_{X}=−φ_{X} (2-12)
0<|ε_{X}|=|φ_{X}|<π/2 (2-13)
In this embodiment, the incident angles between the waves or light rays and the sensing surfaces of the left and right sensors 121, 123 may also be related to each other regardless of the positions of the wave source 400 by the following equations in terms of an angle, “Δ_{Z},” defined as one half of a sum of two incident angles “Ψ_{L}” and “Ψ_{R}” as follows:
Δ₂, (Ψ_{C}+Ψ_{L})/2 (2-14)
Ψ_{L}=Ψ_{C}+Δ₂ (2-15)
Ψ_{R}=Ψ_{C}−Δ₂ (2-16)
I_{L}/I_{C}≈cos(Ψ_{C}+Δ₂)/cos(Ψ_{C}) (2-17)
I_{C}/I_{R}≈cos(Ψ_{C})/cos(Ψ_{C}−Δ₂) (2-18)
I_{R}/I_{L}≈cos(Ψ_{C}−Δ₂)/cos(Ψ_{C}+Δ₂) (2-19)
Once these relationships are established, the equations (2-17) to (2-19) may be solved as described in the equations (1-14) through (1-22) and the incident angles, “Ψ_{L},” “Ψ_{C},” and “Ψ_{R},” may be obtained. From these angles, the target line 420 may be obtained from known position and/or region of the target object 500 and, thereafter, the target point 430 may be calculated from the target line 420 and blocking line 410.

Secondly, the foregoing tilt angles of the sensing elements or sensors 121-123 of the sensor member 100 may be arranged such that their incident angles may be related to each other regardless of the positions of the wave source 400 and/or target object 500. For example, the tilt angles of the left and right sensors 121, 123 along all three axes may be arranged to have nonzero values in order to satisfy one or more of the following relations:
0<ε_{X}=φ_{X}, ε_{Y}=φ_{Y}, and ε_{Z}=φ_{Z}<π/2 (2-20)
0<ε_{X}=−φ_{X}, ε_{Y}=φ_{Y}, and ε_{Z}=φ_{Z}<π/2 (2-21)
0<ε_{X}=φ_{X}, ε_{Y}=−φ_{Y}, and ε_{Z}=−φ_{Z}<π/2 (2-22)
0<ε_{X}=−φ_{X}, ε_{Y}=−φ_{Y}, and ε_{Z}=−φ_{Z}<π/2 (2-23)
where the tilt angles may be related to each other regardless of the location of the wave source 400 or target object 500. It is noted that the incident angles, “Ψ_{L},” “Ψ_{C},” and “Ψ_{R},” must satisfy at least one mathematical relationship regardless of the tilt angles of the sensors 121-123 in the x-, y-, and z-axes, because an equation of a sensing surface of the sensor 121-123 and/or sensor member 100 may be readily obtained from the known tilt angles along the x-, y-, and z-axes, because an equation of a line forming a preset three-dimensional incident angle with the above sensing surface may be obtain d, and because such incident angles may satisfy at least one mathematical equation expressed in terms of the tilt angles. However, by carefully selecting the tilt angles of the sensors 121-123 and/or sensor member 100, mathematical algorithms may be simplified in calculating the incident angles, the target line 420, and/or the target point 430.

Configurational and/or operational variations and/or modifications of the above embodiments of the exemplary wave blocking systems and various methods thereof described in FIGS. 1 to 4 also fall within the scope of this invention. First, the waves or light rays may not necessarily impinge directly upon the sensing surfaces of the sensors at the right angles and, therefore, that the resulting electric currents, “I_{L},” “I_{C},” and “I_{R},” would necessarily be less than those which would be generated thereby when the waves or light rays form the incident angles of π/2. As discussed hereinabove, however, the effects of the angled illumination may be canceled out, benign or kept at a minimum level when the sensors of the sensor member are disposed at the preset tilt angles. Second, the sensor members of the present invention may include any number of sensors and/or sensor units such photovoltaic units arranged in any arbitrary configuration and/or tilt angles and each of the sensor units may include any number of sensors or sensing elements such as photovoltaic cells or solar cells arranged in arbitrary configurations and/or tilt angles, where the photovoltaic unit is generally defined to include at least one photovoltaic cell and electric circuitry therefor. In general, the sensor member theoretically require as few as two sensors or sensing elements or as few as two sensing sensor units each of which may include at least one sensing element or sensor disposed at different tilt angles. By receiving electrical signals from the sensing elements, the control member may calculate the incident angle of the waves and the target point at which the blocking element of the blocking member such as the blocker is to be disposed. Using the minimum number of sensing elements and/or sensor units, however, may not be preferable, because degradation or malfunction of only one of such sensing elements or sensor units may jeopardize entire operation of the wave blocking system. Therefore, it is generally preferred that the sensor member may be arranged to employ redundant configurations, i.e., including one or more sensing elements or sensor units all of which may include a total of at least three sensing elements or sensors at least two of which may be disposed to have different tilt angles. Alternatively, the sensor member may include at least two sensing elements or sensors each arranged to receive such waves or light rays from the wave source at two or more different tilt angles. For example and as shown in FIG. 1, the sensor member may include two sensing elements or sensor units each of which includes any number of sensing elements therein. Similarly and as shown in FIGS. 2 to 4, the left, center, and right sensors may be replaced by a left, center, and right sensor unit each of which may also include any number of sensing elements therein.

The above embodiments, however, exemplify only a few of numerous arrangements in which various sensing elements and/or sensor units of the sensor member of the present invention may be arranged. Following figures represent further embodiments of such sensing elements or sensor units of the sensor member which may allow the control member to calculate the target point based on the electric or optical currents generated thereby.

Accordingly, in another aspect of the present invention, multiple sensor units including multiple sensing elements or sensors may be incorporated into a sensor member such that its sensors may be arranged to receive the waves or light rays at different tilt angles in the three-dimensional space. For example, FIG. 5 denotes a perspective view of another exemplary sensor member of a wave blocking system according to the present invention. A sensor member 100 has an overall configuration which is identical to that of FIG. 4, except that each of a left sensor unit 131, a center sensor unit 132, and a right sensor unit 133 of the sensor member 100 has multiple sensing elements. For example, the left sensor unit 131 includes an upper sensor 131U, a center sensor 131C, a lower sensor 131D, a right sensor 131R, and a left sensor 131L, each of which is arranged to form a shape of a cross. Such sensors are generally identical and disposed on flat sensing surfaces of the sensor units 131-133 so that incident angles of the waves with respect thereto are at least substantially identical to each other for each sensor unit 131-133. Although only one sensor may be necessary for each sensor unit 131-133 as described above, multiple sensors may be incorporated into each sensor unit 131-133 in order to generate multiple signals which may averaged to yield a representative signal to cancel out, if any, idiosyncratic differences between such sensors, to enhance a signal-to-noise ratio, and the like. The multiple signals may be used to sort out signals of low quality or signals generated by malfunctioning sensors. For example, by comparing such signals with their averages, those signals with abnormally high or low intensities may be excluded in calculating averages thereof.

Employing multiple sensors may not only improve reliability and quality of the averaged signals but also increase life of the wave blocking system of this invention. For example, the sensor member 100 may be arranged to operate based on not all but only some of such sensors such as, e.g., upper, lower, and center sensors 131U, 131D, 131C. Upon detection of any abnormality in any of the signals generated thereby, the malfunctioning or degraded sensor may be left out, and other sensors such as the left or right sensors 131L, 131R may be recruited. Thus, a life span of the sensor member 100 and of the wave blocking system 10 may be prolonged. Employing multiple sensors may also enhance efficiency in obtaining the position of a single or multiple wave sources irradiating various waves with different wavelengths or frequencies. For example, the sensor member 100 may be arranged to have various sensors which are capable of detecting the waves or light rays having different wavelengths or frequencies or waves or light rays with different distribution of such wavelengths or frequencies. The sensor which is most sensitive to visible light rays may then determine a first target point in order to protect a target object therefrom, while other sensors which are sensitive to, e.g., ultraviolet rays may calculate a second target point to protect a target object therefrom. Based on the locations of the target points, the control member may position multiple blockers at such target points such that a first blocker blocks transmission of the visible light rays therethrough, whereas the second blocker blocks transmission of the UV rays therethrough. This embodiment is particularly useful when there are two or more wave sources or multiple wave sources emit waves having different wave characteristics. Similarly, the wave blocking system may be arranged to move multiple blockers in multiple target points upon detecting multiple wave sources irradiating identical, similar or different waves or light rays.

In yet another aspect of the present invention, at least one sensing element or sensor may be arranged to receive the waves or light rays at multiple incident angles by changing its position or its tilt angle with respect to the wave source. FIG. 6 shows a perspective view of an exemplary rotatable or movable sensor member of a wave blocking system according to the present invention. As will be described in detail below, a key feature of this embodiment is sensing elements or sensors arranged to translate, rotate or otherwise move in order to receive the waves or light rays at different incident angles according to axial and/or angular positions thereof. For example, multiple sensing elements or sensors such as an upper sensor 141U, a lower sensor 141D, a left sensor 141L, and a right sensor 141R are disposed at four different sides of a planar top surface 142 of a rectangular strip 143 such that the sensors may receive the waves or light rays at at least substantially identical incident angles. The rectangular strip 143 is supported by a vertical rotator 144 arranged to rotate with respect to a base 145 of the sensor member 100, e.g., in a substantially vertical angular direction 146 such that the incident angles between the sensors and waves may vary based on a vertical and/or angular position of the strip 143. The sensor member 100 may preferably include an actuator (not shown in the figure) in a desirable position such as, e.g., beneath the base 145 thereof in a substantially horizontal angular direction 148 such that the incident angles between the sensors and waves may also depend upon a horizontal angular position of the strip 143. Another actuator (not shown in the figure) may be used to effect the horizontal rotation of such sensors. As described above, the sensor member 100 of such an embodiment generally needs only one sensor as long as at least one of the above actuators may rotate the sensor horizontally and/or vertically so that the sensor may receive the waves or light rays at two or more different incident angles. For stability, reliability or sensitivity, however, it is generally preferred that the sensor member 100 include multiple sensors disposed on the top surface 142 of the rectangular strip 143.

In operation, the first actuator translates, elevates or moves the vertical rotator 144 to a preset first elevation, while the second actuator rotates or moves the horizontal rotator 147 to a first angular position such that at least one sensor 141U, 141D, 141L, 141R may be arranged to receive the waves or light rays at first incident angles. After such sensors generate electric signals depending upon the intensities of such waves and incident angles thereof, the first actuator translates, elevates or moves the vertical rotator 144 to a preset second elevation, whereas the second actuator rotates or moves the horizontal actuator 147 to a second angular position in order to receive the waves or light rays at different second incident angles. When desirable, at least one of the rotators 144, 147 may be moved to other elevations and/or angular positions to receive the waves at further different incident angles. Once electric signals are generated by at least one sensor, the control member 300 may calculate the target line 420 and target position 430 to which the blocking element of the blocking member 200 is to be positioned.

Configurational and/or operational variations and/or modifications of the above embodiments of the exemplary wave blocking systems and various methods thereof described in FIG. 6 also fall within the scope of this invention. First, a single actuator may be arranged to position the sensors at multiple vertical elevations and/or angular positions, thereby allowing the sensors to generate multiple electric signals for the control member to calculate the target line and target point. Secondly, the actuator may also be arranged to translate or move at least one of the above rotators in conjunction with the above vertical or horizontal rotations. Any combination of such translation and/or rotation may be sufficient within the scope of the present invention as long as the sensors may generate multiple electric signals for the control member to calculate the target line and target point. At least one of the sensors may be also arranged to have at least one non-planar sensing surface such as, e.g., a concave, convex, and hybrid surface. Such a sensor with curved surfaces may enhance its sensitivity to the incident angle of the waves because its curvature may render at least a portion of the sensor to be less susceptible to the waves with low incident angles. Alternatively, at least one of the sensors may be disposed on the top surface of rectangular strip at a different tilt angle or in different portions of the top surface which may be curved to allow the sensor to receive the waves at different incident angles. Such an embodiment offers the benefit of reducing the number of rotations or translations to be effected by the actuator for the control member to calculate the target point, because different sensors may receive the waves at different incident angles. In the alternative and as described hereinabove, the sensor member may include at least one sensor which may be manipulated by the actuator to be positioned at various elevations and/or angular positions as well.

In another aspect of the present invention, a sensor member may further include at least one reflector arranged to reflect the waves or light rays to the sensors at different incident angles. Such an embodiment may allow even a single stationary sensing element or sensor to receive the waves or light rays at multiple incident angles, thereby obviating an incorporation of the foregoing actuators for translating and/or for rotating the sensing element, sensor unit, and/or sensor member. FIG. 7 shows a perspective view of an exemplary sensor member including a rotatable or movable wave reflector of a wave blocking system according to the present invention. As will be described in detail below, a key feature of such an aspect of the present invention is that at least one sensor may be arranged to be fixedly or movably disposed and that at least one wave reflector is arranged to movably disposed and to reflect the waves or light rays at two or more incident angles as a result of axial and/or angular positions of such a wave reflector. For example, an exemplary sensor member 100 may include a left sensor 151 and a right sensor 152 which are preferably fixedly disposed on a base 153 thereof with their sensing surfaces 154, 155 oriented upright in opposing fashion. An exemplary wave reflector 156 may be rotatably positioned between the above sensors 151, 152 and generally include multiple reflecting surfaces 157 such as tetrahedral ones as shown in the figure. Such a wave reflector 156 also includes a rotating base 158 to which the rotating surface 157 are coupled and which is rotatably positioned with respect to the base 153 of the sensor member 100. The sensor member 100 may also include at least one actuator which is arranged to rotate the base 158 and/or reflecting surfaces 157 in a horizontal and/or vertical angular directions 159.

In operation, the actuator moves and positions the rotating base 158 at a first angular position such that at least one reflecting surface 157 may be arranged to receive the waves or light rays and to reflect or to distribute them toward the sensing surfaces 154, 155 of the left and right sensors 151, 152 at first incident angles. After the sensors 151, 152 generate the electric signals depending upon intensities of the waves and incident angles with respect to the sensors 151, 152, the actuator then moves or rotates the base 158 to a second angular position in order to reflect the waves or light rays to the sensing surfaces 154, 155 at different second incident angles. When desirable, the base 158 may be moved to other positions to provide the waves or light rays impinging on the sensors 151, 152 at different incident angles. Once enough number of electrical signals are generated by the sensors 151, 152, the control member 300 calculates the target line 420 and target position 430 to which the blocker 211 of the blocking member 200 is to be positioned.

Configurational and/or operational variations and/or modifications of the above embodiments of the exemplary wave blocking systems and various methods thereof described in FIG. 7 also fall within the scope of this invention. For example, the actuator may be arranged to vertically rotate or translate the wave reflector in conjunction with the horizontal rotation as described hereinabove. As far as the sensors may generate enough number of electric signals for the control member to assess the target line and direction, any number of horizontal rotations, vertical rotations, and/or linear translations may be effected by the actuator. When desirable, the actuator may also be arranged to rotate the sensors horizontally or vertically and/or to translate them along an axis of the base of the sensor member or at an inclined angle thereto. The wave reflector may also be arranged to include any number of planar or curved reflecting surfaces which are disposed fixedly or movably at any angles with respect to the base and/or sensors of the sensor member. As described hereinabove, any combination of the reflecting surfaces may be incorporated into the wave blocking system as long as the sensors may generate enough number of electric signals for the control member to assess the target line and target point. For example, at least one of the reflecting surfaces may be arranged to have a curved surface capable of reflecting the waves or light rays toward the sensors. Both planar and curved reflecting surfaces may be arranged to be incrementally or continuously positioned at preset elevations and/or angular positions. This embodiment may offer the benefit of reducing the number of translations and rotations to be effected by the actuator in order to allow the control member to assess the target line and point. Alternatively and as described hereinabove, the wave reflector may also include a single reflecting surface which may be manipulated by the actuator to be positioned at different elevations and/or angular positions.

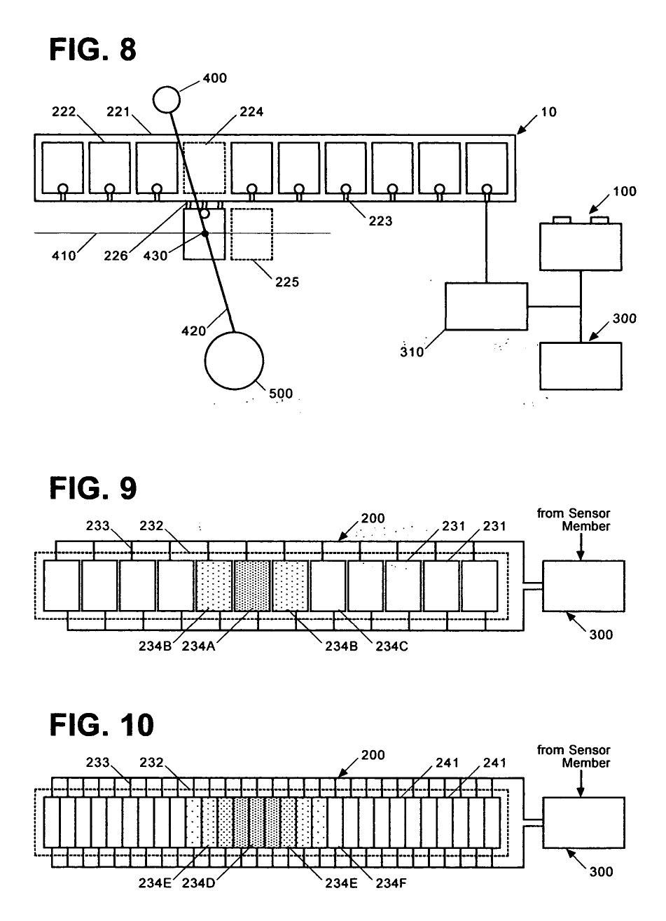

In yet another aspect of the present invention, multiple light blocking elements such as blocking pads may be arranged to be disposed at preset locations along a blocking direction and to operate or move between their off- and on-positions. This embodiment does not generally require translational movements and/or rotation of the blocking pads along the blocking direction. Rather, the blocking pads may translate, rotate, flip or otherwise displace at least a portion thereof along a shorter distance and, therefore, may respond to the waves or light rays more rapidly. FIG. 8 shows a schematic diagram of another exemplary wave blocking system according to the present invention, where a wave blocking system 10 is employed so as to protect a target object 500 from directly being irradiated by the waves or light rays.

An exemplary wave blocking system 10 may include a sensor member 100, a blocking member 200, and a control member 300. The sensor member 100 is at least substantially similar or identical to those of the foregoing aspects of this invention, e.g., those described in FIGS. 1 through 7, such that it receives a first portion of the waves or light rays from a wave source 400 and generates at least one electric signal in response thereto. The blocking member 200 includes a body 221 which is shaped as a housing and which extends along a blocking direction 410. The blocking member 200 also includes multiple blocking elements such as blocking pads 222 arranged horizontally, e.g., side by side or in a row, and movably retained within or by the housing 221. The blocking member 200 may also include multiple couplers 223 movably coupling at least portions of the blocking pads 222 to the housing 221. The blocking pads 222 may generally be arranged to receive a second portion of the waves and be comprised of or include opaque, semi-opaque, semitransparent, reflective or light-absorbing materials in order to block at least a portion of the second portion of the waves from transmitting therethrough. Examples of such materials may include, but not be limited to, conventional light and/or sound blocking materials, reflecting materials, absorbing materials, and so on. The blocking pads 222 are arranged to have rectangular, square, circular, oval or other curvilinear polygonal shapes and to be spaced apart or to overlap each other. The housing 221 may generally extend along a curvilinear blocking direction 410 which may typically be transverse to a two- or three-dimensional curvilinear target line 420 which is arranged to pass through the wave source 400 and target object 500. The housing 221 may have any shapes capable of supporting and for movably retaining at least portions of the blocking pads 222 therein. The couplers 223 may be generally arranged to couple the blocking pads 222 to the housing 221 movably, e.g., slidingly or rotatably such that the blocking pads 222 may be flipped from their off-position to their on-position or vice versa. The wave blocking system 10 may also include an actuator to effect such flipping movements of the blocking pads 221.

In operation, all of the blocking pads 222 of the blocking member 200 are maintained in their off-positions. As the sensor member 100 receives the first portion of the waves from the wave source 400, it generates the electric signals in response thereto and sends the signals to the control member 300 which then calculates the location of the wave source 400 based at least partially on the signals and calculates the two- or three-dimensional target line 420 as well as the two- or three-dimensional coordinate values of the target point 430. The control member 300 then manipulate an actuator 310 to flip one of the blocking pads 222 disposed at the target point 430 from its off- to on-position in order to protect the target object 500 from being directly impinged by the waves or light rays. When the wave source 400 and/or target object 500 changes its position, the sensor member 100 receives another portion of the waves in different incident angles, generates different electric signals, and sends such to the control member 300 which then calculates a new location of the wave source 400 and/or target point 500. When the new target point 500 is within a preset threshold range from the previous target point 500, the control member 300 maintains the same blocking pad in its on-position 225. Otherwise, the control member 300 manipulates the actuator 310 so as to flip the previous blocking pad to its off-position 224 and to flip a new blocking pad disposed at the new target point 430 from its off-position 224 to its on-position 225.

Movements of the blocking pads 222 of the blocking member 200 may be realized by various embodiments. For example and as exemplified in FIG. 8, the blocking pads 222 may be hingedly and rotatably coupled to the housing 211 by the connector 223. The blocking member 200 may include a string, chain or other force-transmitting article which is mechanically coupled to the blocking pads 222 and pulled or pushed by the actuator 310 in order to flip the blocking pads 222 between their off- and on-positions 224, 225. An elastic or recoil unit 226 may be incorporated so that the actuator 310 flips the blocking pads 222 from their off- to on-positions 224, 225, whereas the elastic or recoil unit 226 flips the blocking pads 222 back to their unstressed position which may be arranged to be either the off- or on-position 224, 225. The blocking pads 222 may also be arranged to move horizontally and/or vertically in addition to the foregoing flipping movements. In addition, by providing another actuator for controlling vertical displacements, the control member 300 may position the blocking pads 222 in any three-dimensional position determined thereby. In the alternative, the housing 221 may be arranged to form multiple guides or slits along which at least a portion of the blocking pad 222 may be arranged to slide up and down. Other embodiments of displacement mechanisms may also be used as long as the actuator 310 may manipulate at least a portion of the blocking pad 222 to be positioned at the desired target point 430 and to be displaced therefrom.

In yet another aspect of the present invention, a blocking member may also employ at least one non-mechanical, optoelectric blocking elements and/or blocking units which may be generally arranged to be fixed or movably disposed along a blocking line or direction and to change their states according to electrical or optical manipulation by a control member, e.g., from a transparent, semi-transparent or translucent off-state to an opaque, semi-opaque, reflecting or absorbing on-state or vice versa. This embodiment does not require any mechanical movements of the blocking elements and/or actuators of the control member and, thus, does not generally require many mobile parts in the blocking member or actuators. Therefore, such an embodiment allows easier fabrication of more compact wave blocking systems. FIG. 9 is a schematic diagram of yet another exemplary wave blocking system according to the present invention, where an exemplary wave blocking system 10 is applied to block the foregoing waves or light rays from directly illuminating a target object 500. It is appreciated that, for the sake of simplicity of explanation, FIG. 9 does not include any sensor members, wave source, and target object and that any of the sensor members described herein may be used in conjunction with the exemplary wave blocking system of such a figure.

An exemplary wave blocking system 10 may include a sensor member 100, a blocking member 200, and a control member 300. The sensor member 100 is at least substantially similar or identical to those of the foregoing aspects and/or embodiments of this invention such as receiving a first portion of various waves and generating at least one electric and/or optical signals in response thereto. The blocking member 200 includes at least one blocking element such as a blocking unit 231, at least one body such as a support 232, and electrical or optical circuitry 233 arranged to operatively couple the blocking unit 231 to the control member 300. The support 232 may extend along a blocking line and/or direction 410 and have a preset height to cover a preset horizontal and vertical region in front of the target object 500. The blocking unit 231 may typically include multiple blocking cells 234 arranged to be disposed on and/or supported by the support 232 and to be aligned along the support 232 side by side along the blocking direction 410. The blocking cells 234 may be arranged to receive a second portion of the waves and generally composed of materials having at least two optical states in which optical characteristics thereof such as absorption, reflection, and/or transmission of the waves or light rays thereby and/or therethrough may change when provided with electric current, electric voltage, and/or optical signals. For example, such blocking cells 234 may operate between at least one non-blocking state and at least one blocking state, where such cells 234 may become at least partially transparent, semi-transparent, translucent, non-absorbing, and/or non-reflecting in the non-blocking state in order to transmit at least a portion of the second portion of the waves or light rays therethrough and where such cells 234 may become at least partially opaque, absorbing, and/or reflecting in the blocking state so as to block at least a substantial portion of the second portion of the waves or light rays thereby. The electrical or optical circuitry 233 is arranged to electrically or optically couple at least a substantial number of the blocking cells 234 to the control member 300 which may manipulate operating states of at least a substantial number of such cells 234. The blocking unit 231 of FIG. 10 may be fabricated, e.g., by assembling multiple cells 234 on the support 232 and providing electric or optical circuitry 233 thereto. Alternatively and particularly when semiconductive materials are used for manufacturing the cells 234, the entire blocking unit 231 may preferably be manufactured by conventional semiconductor fabrication processes such that different layers of the blocking cells 234 may be deposited over the support 232 or provided by doping processes, the requisite circuitry 233 may be formed by etching, doping, and/or depositing processes, and the like.

The control member 300 is operatively coupled to the sensor member 100 so as to receive the electrical and/or optical signals generated thereby and arranged to calculate a location of the wave source 400 based at least partially on such signals, to obtain the two- or three-dimensional curvilinear target line 420 from the location of the wave source 400 and target object 500, and to assess a target point 430 generally corresponding to a two- or three-dimensional point of intersection 430 between the blocking line or direction 410 and target line 420. Contrary to the control members of the foregoing aspects and embodiments of this invention described heretofore, the control member 300 of the above aspect of this invention does not require any of the foregoing actuators. Rather, the control member 300 is arranged to provide the blocking cells 234 with electric current, electric voltage, and/or optical signals and to manipulate such cells 234 so that the cells 234 disposed at or near the target point 430 change from the non-blocking to blocking state, while the rest of the blocking cells 234 remain in their non-blocking state. Accordingly, an operator or driver may be spaced from being directly illuminated by the waves or light rays, while maintaining a satisfactory forward view. Other features of such a control member 300 may be similar or identical to those described hereinabove.

In operation, the blocking member 200 is fixedly disposed between the wave source 400 and target object 500. Before the wave blocking system 10 is engaged, all blocking cells 234 are in their off-state which may correspond to either of the non-blocking or blocking state. When the system 10 is engaged, at least a substantial number of the cells 234 are arranged to be maintained in their non-blocking state. When the sensor member 100 receives the first portion of the waves or light rays and generates the electric or optical signals, the control member 300 receives such signals and calculates the location of the wave source 400 and obtains the two- or three-dimensional curvilinear target line 420 and the two or three-dimensional coordinate values of the target point 430. The control member 300 then provides the electric or optical power to the blocking cells 234 disposed at or near the target point 430 and change their optical characteristics into the blocking state, while keeping the other cells 234 in their non-blocking state. When the relative position between the wave source 400 and target object 500 changes, the sensor member 100 generates the electric or optical signals having different intensities and the control member 300 calculates a new target point 430 and manipulates the blocking cells 234 disposed at or near the new target point 430 into their blocking state, while keeping the rest of the cells 234 in their non-blocking state. When the blocking cells 234 are arranged to operate in the blocking state, non-blocking state, and an intermediate state, the control member 300 may be arranged to control the blocking cells 234 to block the waves or light rays in an incremental or semi continuous manner, e.g., by manipulating the transmittivity or reflectivity of the cells 234 at their lowest level at or near the target point 430, those of the cells 234 at their intermediate level around the target point 430, and those of the cells 234 at their highest level away from the target point 430.

Various optoelectric technologies may be employed to manufacture the blocking member 200, its blocking units 231, and/or its blocking cells 234 of the present invention. For example, the blocking cells 234 may be arranged to change or alter color, clarity, transparency, polarity, crystalline structure such as its orientation, transmittivity of the waves or light rays therethrough, planes of vibration of the waves or light rays therethrough, and so on, when they are stimulated by the electric current, electric voltage, optical signals, and so on. A typical example of the blocking cells 231 including such blocking cells 234 is a liquid crystal display unit where a pair of polarizers or polarizing filters is disposed in an opposite fashion and where a layer of liquid crystal is sandwiched therebetween. In order to provide the electric current or optical signals therethrough, a pair of electrodes or optical conduits may also be disposed at interfaces between the polarizers and liquid crystal layer. The polarizers and electrodes are preferably comprised of or include at least partially transparent, semi-transparent or translucent materials such that the waves or light rays may be at least partially transmitted therethrough when the liquid crystal layer may be in the non-blocking state. The polarizers may be generally oriented to have their planes of vibrations of the polarized waves or light rays transmitted therethrough transverse to or, in particular, perpendicular to each other. Liquid crystal molecules in the liquid crystal layer may be twisted in a direction starting from one polarizer to the other. Thus, the liquid crystal molecules may form starting tilt angles with a polarizing direction of one polarizer and also form ending tilt angles with a polarizing direction of the other polarizer. Because the liquid crystal molecules of the blocking cells 234 twist planes of vibration of the waves or light rays transmitting therethrough, the above tilt angles and twist angles of the liquid crystal molecules are preferably selected such that, in the non-blocking state, the waves or light rays are polarized by one polarizer, propagate through the liquid crystal layer while being twisted along the liquid crystal molecules, and are then transmitted out through the other polarizer. The liquid crystals may also be arranged to change alignment thereof in the blocking state as the electric current, electric voltage or optical signals are applied thereto such that at least a portion of the waves or light rays may be less twisted and may not be transmitted out of the other polarizer. When desirable, any of the polarizers and/or both the tilt and twist angles may be arranged differently from the above such that the liquid crystal molecules are in the nonblocking state when provided with the electric or optical energy and that the liquid, crystal molecules are in the blocking state when such energy ceases to be supplied thereto. Other materials may also be used to build such blocking units 231 as well. For example, the blocking units 231 may include multiple blocking cells 234 comprised of or including materials capable of altering color, transparency or reflectivity of the waves by applying the electric or optical energy thereto such that they may selectively block the waves or light rays with preset wavelengths or frequencies.

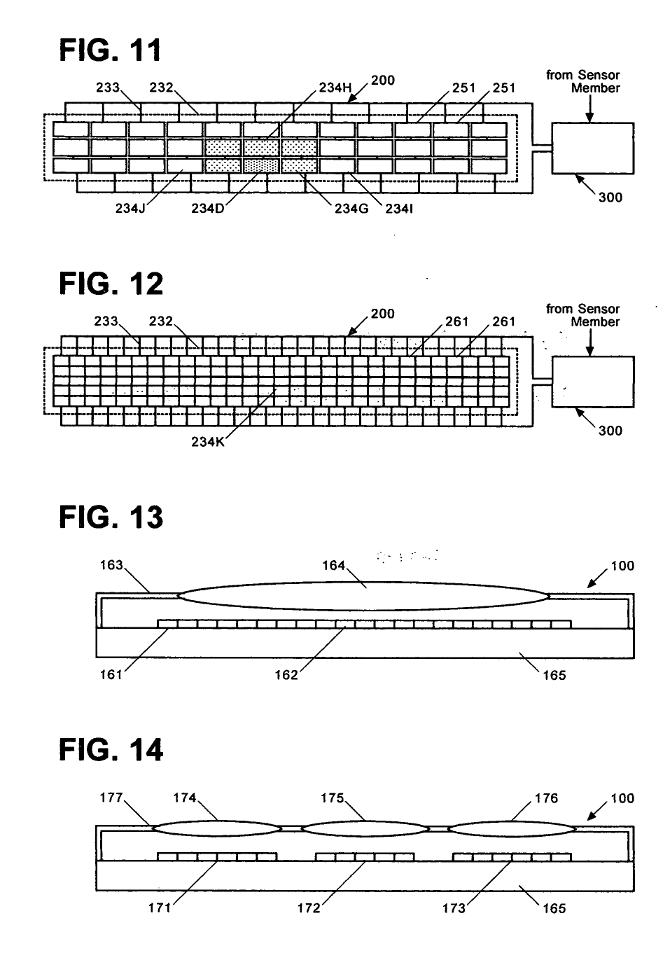

Configurational and/or operational variations and/or modifications of the above embodiments of the exemplary systems and various methods thereof described in conjunction with FIG. 9 may also fall within the scope of this invention, where exemplary embodiments of such are described in following FIGS. 10 to 12 which are schematic diagrams of other exemplary wave blocking systems according to the present invention. For example, blocking units 241, 251, 261 of FIGS. 10 through 12 may all include blocking cells 234 which are at least substantially similar to or identical to those of FIG. 9 but may be arranged to have different shapes and/or sizes and to be disposed in rows, columns, and/or arrays. More particularly, the blocking unit 241 of FIG. 10 includes more blocking cells 234 which are arranged in a row such that the blocking unit 241 may form a spectrum of blocking cells 234 in the blocking state such that center cells 234D disposed at or near the target point 430 have the greatest transmittance, neighboring cells 234E disposed around the target point 430 may have an intermediate transmittance, and the rest of the cells 234F disposed beyond a preset distance from the target point 430 may have the least transmittance. In contrary, the blocking unit 251 of FIG. 11 includes an array of blocking cells 234 which may form a spectrum of incremental transmittances in some of the cells 234J, 234D, 234G, 234I horizontally and in others 234D, 234H vertically when such cells 234D, 234G, 234H, 234I, 234J are provided with the electric or optical energy. Therefore, such a blocking unit 251 may still provide a clear forward view horizontally and vertically while protecting a driver or operator from being directly illuminated by the waves or light rays. The blocking unit 261 of FIG. 12 may include the blocking cells 234 having even smaller sizes and arranged in both horizontal and vertical directions in order to form an almost continuous spectrum of varying transmittances in their blocking state. It is appreciated that each of the above blocking cells 231, 241, 251, 261 may preferably include electric or optical circuitry operatively coupling the cells 231, 241, 251, 261 to the control member 300. It is also appreciated that such cells 231, 241, 251, 261 may have any shapes and/or sizes and may be arranged in any modes as long as the control member 300 may manipulate their various optical characteristics between their blocking, non-blocking, and/or intermediate states.

In another aspect of the present invention, exemplary wave blocking systems may also employ sensor members arranged to assess locations of the wave source by monitoring temperature and/or brightness by multiple sensor members, sensor units, and/or sensors which are disposed in a column, row, and/or array. For example, instead of generating the electric or optical signals, the sensors may receive the waves or light rays at different incident angles and then heated to different temperatures. By arranging the sensors in preset angles, the control member may correlate tilt angles of the sensors which are heated to the highest temperature with the incident angle of the wave source and assess the target point based upon the tilt angle of such a sensor. In the alternative, the control member may measure brightness of the sensors due to the waves or light rays received thereby and then identify the sensor with the maximum brightness. Therefrom, the control member may calculate the incident angle of the waves or light rays from the tilt angle of such a sensor and then assess the target point therefrom. It is appreciated that these sensor members of this aspect of the invention do not include any mobile parts and that the control members therefore do not have to require actuators either. When desirable, at least some of such sensors may be arranged to be movable and/or the sensor members may include the foregoing wave reflectors as described herein. Such sensor members may further be arranged to include other features of the foregoing aspects and/or embodiments as well.

In another aspect of the present invention, a sensor member may include at least one optical element capable of intensifying (or concentrating) or attenuating (or diffusing) the waves or light rays onto and/or away from various sensor members, sensor units, and/or sensors in order to enhance an efficiency and/or sensitivity thereof. Any conventional optical elements such as, e.g., lenses, prisms, and so on, may be used for this purpose as long as they may alter propagation paths of the waves. For example, FIGS. 13 and 14 show schematic views of further exemplary sensor members of wave blocking systems according to the present invention. In an exemplary embodiment shown in FIG. 13, a sensor member 100 may include a sensor unit 161 which may be any of the foregoing sensor units or which may include any of the foregoing sensors. The sensor member 161 also includes a frame 163 which may be disposed around the sensor unit 161 and fixedly support a concave lens 164 gen rally on top of the sensor unit 161. When the waves or light rays impinge upon the lens 164, they may be diffracted toward its focal point and concentrated on one or more sensors 162 which then generate the electrical or optical signals with amplitudes different from those generated by other sensors 162 disposed away from a region of concentrated waves or light rays. The control member 300 may then be arranged to calculate the incident angle of the waves or light rays and to calculate the target line based upon, e.g., a location of the sensor which generates the signal with the greatest amplitude, the amplitude of such a signal, distribution of the signals and/or their amplitudes, and the like. In another exemplary embodiment of FIG. 14, another sensor member 100 may include multiple sensor units 171-173 which may be respectively disposed under multiple concave lenses 174-176 each of which may be supported by a frame 177. In either embodiment, the sensors of the sensor units 161, 171-173 are disposed at the same or different tilt angles as described above, amy be disposed fixedly or movably with respect to the bodies 165, 175 of the sensor member 100, and so on. Alternatively, the concave lenses 164, 174-176 may be arranged to rotate or translate in a preset pattern in order to concentrate the waves or light rays in different portions of the sensor units 161, 171-173. When desirable, other optical elements such as, e.g., convex lenses, prisms, and/or mirrors, may be employed along with the concave lenses 164, 174-176 and/or at least one of such optical elements may be arranged to rotate or translate vertically and/or horizontally such that an entire lens assembly may zoom in and/or out the waves or light rays. It is appreciated that the two- and/or three-dimensional mathematical algorithms described hereinabove may also be applied to these various aspects and/or embodiments described herein as far as precise locations of such optical elements and multiple sensors may be provided with respect to those of the sensor members, sensor units, and/or sensors and as long as their optical or operative characteristics such as their shapes, sizes, and/or focal lengths may be provided a priori. Other features of the foregoing aspects and embodiments of this invention may also be applied to the exemplary wave blocking systems of FIGS. 13 and 14.

Configurational and/or operational variations and/or modifications of the above embodiments of the exemplary wave blocking systems and various methods thereof described in FIGS. 1 to 13 also fall within the scope of this invention.

First of all, the sensor member of the wave blocking system may have arrangements different from those described hereinabove. Therefore, any conventional devices may be used as the sensors as long as such devices may generate various signals which the control member may recognize and use to assess locations of the wave source and target point. For example and as described above, various conventional optoelectric devices, temperature sensors, and/or brightness sensors may be used in order to generate electric, optical, and/or temperature signals in response to various waves or light rays. Other conventional sensors may also be used as long as they generate different signals in response to changes in the incident angles of such waves or light rays with respect to such sensors. It is to be understood that such sensors may have any shapes and/or sizes and may be arranged in any configuration as long as they may generate non-identical signals in response to such changes in the incident angles. Accordingly, selection of the shapes, sizes, and/or arrangements of the sensors is generally a matter of choice of those skilled in the relevant art.

Similarly, the blocking member of the wave blocking system may have arrangements different from those described hereinabove as well. Therefore, any conventional devices may be used as the blocking elements of the blocking member as far as the devices may selectively transmit the waves or light rays therethrough and/or block the waves or light rays therethrough. In addition, such blocking elements may have any shapes, sizes, and/or arrangements as long as they may perform the above functions. For example and as described above, the blocking elements may be arranged to translate, rotate or otherwise move between their on- and off-positions respectively to block and transmit such waves or light rays. In the alternative, the blocking elements may be arranged to change their optical characteristics between their blocking and non-blocking states respectively to block and transmit such waves or light rays as well. Accordingly, selection of the shapes, sizes, and/or arrangements of the blocking elements is generally a matter of choice of those skilled in the relevant art.

At least a portion of the above sensor, blocking, and/or control members may be combined into each other in order to form a hybrid member. For example, various units or elements of the foregoing sensor member such as, e.g., photovoltaic cells and/or requisite circuitry, may be incorporated into the blocking and/or control members as long as such units or elements may be able to receive the waves or light rays. Various units or elements of the above control member such as, e.g., electrical or optical circuits and/or microchips encoded with one of the foregoing mathematical algorithms may similarly be incorporated into the sensor and/or blocking members. Accordingly, overall arrangements of various members and/or units of the wave blocking system of the present invention may not be material to the scope of the present invention as long as such a system may perform the aforementioned functions such as, e.g., generating various signals in response to the waves or light rays, analyzing the signals to assess locations of the wave source and/or target point, and selectively blocking a portion of such waves or light rays to spare the driver or op rator from directly receiving the waves or light rays.

In general, the wave blocking systems of this invention may require two- or three-dimensional position of the target object. Because the position of the driver seat is rather fixed inside the vehicle, the position of the target object such as, e.g., his or her eyes, may be supplied to the wave blocking system as an input constant a priori. Alternatively, the wave blocking systems may be supplied with multiple positions of the target object and the driver of the vehicle or operator of the instruments may be able to select one or more preferred positions from the preset multiple positions depending upon his or her height, precise position of the driver or operator seat, and the like. When desirable, the wave blocking systems may be arranged such that the driver or operator may input his or her position into the systems. In another alternative, the wave blocking systems may include at least one conventional tracking device capable of tracking the precise position of the target object at preset intervals and/or continuously and supplying such a position to the system as a system input constant.

It is preferred that the wave blocking system and method of the present invention positions the blocking element and/or at least a portion of the blocking member at the target point in order to block at least a portion of the waves propagating through such a point. Therefore, the blocking element and/or the portion of the blocking member may be positioned preferably at the three-dimensional target point. When the blocking line or direction may not pass through the target point or when the blocking line or direction may not intersect the target line, the blocking element and/or such a portion of the blocking member may not be disposed precisely at the target point. This may happen when the blocking line or direction may be defined to be two-dimensional or when the wave source may move beyond a preset domain defined by such a wave blocking system. In such cases, the blocking element or the portion of the blocking member may be disposed at a position which may be nearest or closed to the target point or line and/or at another position which may correspond to a vertical projection of the target point onto the blocking line and/or direction.

The wave blocking systems of the present invention are operated by electric power supplied according to various embodiments. For example, such systems may be operated by electric power of the vehicle or instruments or by conventional batteries. Alternatively, such systems may be operated by electric power generated by the sensing elements or sensors of the sensor member. In such an embodiment, the sensors such as photovoltaic cells may not only generate the electric signals which are supplied to the control member to assess the target point but also supply the extra electric current to the wave blocking system itself to power various members thereof. When desirable, the foregoing embodiments may also be used in combination.

The wave blocking systems of the present invention may be disposed in any place between the wave source and target object. Accordingly, such systems may be preferably disposed on top portions of front window of the vehicles such that the sensor member may receive the waves, while not obstructing the forward view of the driver. However, such systems may be disposed inside the passenger compartment as long as the sensor member may receive the waves, the blocking member may be disposed between the wave source and target object so as to block the waves from directly illuminating the driver, and so on. Therefore, the wave blocking systems may include a reset member which is arranged to reset system parameters and initial conditions thereof such as, e.g., a position of the target object, and so on.

As described herein, the sensing elements or sensors of the sensor member may go through regular wear and tear and generate the signals including systematic errors. In addition, the driver or operator may seat himself or herself in an irregular posture, and so on. All of these factors may result in a discrepancy between the calculated target point and an actual target point, and the wave blocking system may allow a portion of the waves to directly illuminate the target object. In order to avoid such a systematic error, the wave blocking system may include a calibration unit through which the driver or operator may supply a two- or three-dimensional offset to the wave blocking system which then calibrates the target point by such an offset and positions the blocking element or such a portion of the blocking member at the calibrated target point.

It is to be understood that, while various aspects and embodiments of the present invention have been described in conjunction with the detailed description thereof, the foregoing description is intended to illustrate and not to limit the scope of the invention, which is defined by the scope of the appended claims. Other embodiments, aspects, advantages, and modifications are within the scope of the following claims.

1. A wave blocking system for protecting at least one target object from directly receiving waves emitted by at least one wave source comprising:
at least one sensor member configured to receive waves emitted by said wave source and to generate at least on signal in response thereto;
at least one blocking member configured to define at least one blocking direction and to include a movable blocking element which is configured to move along said blocking direction and to block at least a substantial portion of said waves received thereby from transmitting therethrough; and
at least one control member configured to be operatively coupled to said sensor and blocking members, to receive said signal from said sensor member, to assess a position of said wave source, to assess a target line configured to pass through said wave source and target object, to move at least a portion of said blocking element to a position disposed along said blocking direction and nearest to said target line so as to block said waves from directly illuminating said target object while providing an optimum forward view to said target object.

2. A wave blocking system of claim 1, wherein said sensor member is configured to include a plurality of sensing elements each of which is configured to be disposed at an unique tilt angle and to generate said signal which is configured to be a function of an incident angle between said sensing element and waves which is also configured to be a function of said tilt angle.

3. A wave blocking system of claim 1, wherein said blocking direction is configured to be at least partially transverse to said target line.

4. A wave blocking system of claim 1, wherein said blocking element is configured to include at least one of an opaque, reflecting, and semi-opaque material.

5. A wave blocking system of claim 1 further comprising at least one actuator configured to move said blocking element along said blocking direction and wherein said control member is configured to be operatively coupled to and to manipulate said actuator to move said blocking element.

6. A wave blocking system for protecting at least one target object from directly receiving waves emitted by at least one wave source comprising:
at least one sensor member configured to receive waves emitted by said wave source and to generate at least one signal in response thereto;
at least one blocking member including a plurality of blocking elements which are configured to operate between at least one blocking state and at least one non-blocking state by changing at least one optical characteristics thereof between said states, to block at least a substantial portion of said waves from transmitting therethrough in said blocking state, and to transmit said substantial portion of said waves therethrough in said non-blocking state; and
at least one control member configured to be operatively coupled to said sensor and blocking members, to receive said signal from said sensor member, to assess a position of said wave source, to assess a target line which is configured to pass through said wave source and target object, and to manipulate said optical characteristics of at least one of said blocking elements disposed within a preset distance from said target line to be in said blocking state in order to block said waves from directly illuminating said target object while manipulating said optical characteristics of the rest of said blocking elements to be in said non-blocking state in order to provide an optimum forward view to said target object.

7. A wave blocking system of claim 6, wherein said sensor member is configured to include a plurality of sensing elements each of which is configured to be disposed at an unique tilt angle and to generate said signal which is configured to be a function of an incident angle between said sensing element and waves which is also configured to be a function of said tilt angle.

8. A wave blocking system of claim 6, wherein said blocking element is configured to include at least one liquid crystal molecule.

9. A wave blocking system of claim 8, wherein said optical characteristics is configured to be a molecular alignment of said liquid crystal molecule such that said molecule is configured to align in one direction in said blocking state and to align in a different direction in said non-blocking state.

10. A wave blocking system of claim 6, wherein said blocking direction is configured to be at least partially transverse to said target line.

11. A wave blocking system of claim 6, wherein at least a portion of said blocking elements are configured to be arranged in at least one of a row, a column, and an array.

12. A wave blocking system of claim 6, wherein said blocking elements are configured to operate in at least one intermediate state in which said blocking elements are configured to transmit a portion of said waves therethrough which is configured to be greater than in said blocking state but less than said non-blocking state.

13. A wave blocking system of claim 12, wherein said blocking elements are configured to form a first region having a first transmittivity of said waves when disposed within said preset distance from said target line, a second region thereof having a second transmittivity of said waves which is greater than said first transmittivity when disposed farther than said preset distance but within another preset distance from said target line, and a third region thereof with a third transmittivity of said waves which is greater than said first and second transmittivities of said waves when disposed farther than said another preset distance from said target line.

14. A wave blocking system of claim 6, wherein at least a portion of said blocking elements are configured to be arranged in a blocking direction and wherein said control member is configured to assess said target line in a two-dimensional space, to assess a target point as a point of projection from said target line onto said blocking direction, and to determine said at least one of said blocking element as one disposed within another preset distance from said target point.

15. A wave blocking system of claim 6, wherein at least a portion of said blocking elements are configured to be arranged in a blocking direction and wherein said control member is configured to assess said target line in a three-dimensional space, to assess a target point as a point of intersection between said blocking direction and target line, and to determine said at least one of said blocking element as one disposed within another preset distance from said target point.

16. A wave blocking system of claim 6 further comprising at least one wave reflector configured to reflect said waves toward said sensor member.

17. A wave blocking system of claim 16, wherein said wave reflector is configured to be movable and to reflect said waves toward said sensor member in a plurality of directions.

18. A wave blocking system of claim 6 further comprising at least one optical element configured to diffract said waves toward said sensor member.

19. A wave blocking system of claim 18, wherein said optical element is configured to be movable and to diffract said waves toward said sensor member in a plurality of directions.

20. A method of protecting at least one target object from being illuminated by waves emitted by at least one wave source comprising the steps of:
disposing a plurality of blocking elements;
assessing a position of said target object;
generating at least one of an electric signal and optical signal in response to said waves;
assessing a position of said wave source at least partially based on said signal;
changing optical properties of at least one of said blocking elements disposed between said wave source and target object to block said waves received thereby from transmitting therethrough, while keeping optical properties of the rest of said blocking elements to transmit said waves received thereby;
tracking a change in said position of said wave source with respect to said target object; and
repeating said changing and keeping, thereby protecting said target object from being directly illuminated by said waves.
